(19) United States
(12) Patent Application Publication
(10) Pub. No.: US 2026/0292855 A1
(43) Pub. Date: Sep. 24, 2026

(54) DEVICE-SPECIFIC HOP LIMITS FOR RELAY HANDLING

(71) Applicant: QUALCOMM Incorporated, San Diego, CA (US)

(72) Inventors: Sunghoon KIM, San Diego, CA (US); Hong CHENG, Basking Ridge, NJ (US)

(21) Appl. No.: 19/570,663

(22) Filed: Mar. 18, 2026

Related U.S. Application Data
(60) Provisional application No. 63/775,959, filed on Mar. 21, 2025.

(51) Int. Cl. H04W 72/25; H04W 8/00; H04W 76/14

(52) U.S. Cl. CPC H04W 72/25; H04W 8/005; H04W 76/14

(57) ABSTRACT

This disclosure provides methods, components, devices and systems for device-specific hop limits for relay handling. For example, a first user equipment (UE) may transmit control information that indicates a UE-specific hop limit to a second UE that is associated with a UE-to-UE network, and the first UE, the second UE, or both, may perform communications of the UE-to-UE network in accordance with the UE-specific hop limit. In some implementations, the first UE may set the UE-specific hop limit based on a latency threshold, a service associated with the first UE, or other parameters. In some implementations, the first UE may transmit the control information as a link establishment message, a link modification message, an identifier (ID) update message, or a discovery information message. In some implementations, a relay UE may receive the control information and determine whether or not to forward the control information based on the UE-specific hop limit.

### CROSS REFERENCE

This present Application for Patent claims benefit of U.S. Provisional Patent Application No. 63/775,959 by KIM et al., entitled “DEVICE-SPECIFIC HOP LIMITS FOR RELAY HANDLING,” filed Mar. 21, 2025, which is assigned to the assignee hereof, and expressly incorporated herein.

### TECHNICAL FIELD

This disclosure relates generally to wireless communication, and more specifically to systems, devices, methods, and techniques associated with device-specific hop limits for relay handling.

### DESCRIPTION OF THE RELATED TECHNOLOGY

Communication systems are deployed to provide communication services such as voice, video, packet data, messaging, or broadcast, among others. A communication system may include a wireless communication network (such as a radio access network (RAN)) that supports communication between wireless communication devices such as network entities (such as base stations), client devices (such as one or more user equipments (UEs)), and others. Such devices may communicate with one another using a variety of protocols (such as radio access technologies (RATs)), including those of cellular-based systems such as fourth generation (4G) systems (such as Long Term Evolution (LTE) systems), fifth generation (5G) systems (such as 5G New Radio (5G-NR) systems), and sixth generation (6G) systems. A wireless communication network may support communication by implementing system resources (such as frequency resources, time resources, spatial resources) in accordance with a wireless communication protocol.

Some wireless communication systems may include a UE-to-UE network, such as a mobile ad-hoc network (MANET), in which a set of UEs may establish a link with one another and relay information among UEs (e.g., between end UEs). In some cases, a MANET may be associated with a single relay service code (RSC), which may be provided by a network entity, a UE within the MANET, or another entity. Each member of the MANET may be referred to as a relay UE (e.g., a UE-to-UE (U2U) relay UE), and an end UE for an instance of communication via the MANET may be a UE (e.g., of the MANET, adjacent to the MANET) that is the initial transmitter or intended recipient of the instance of communication, such that a given UE may be a relay UE or an end UE depending on communication circumstances. In some cases, each instance that a communication is relayed (e.g., transmitted, broadcasted) between UEs associated with the MANET (e.g., relay UEs, end UEs) may be referred to as a hop. A MANET in which a communication may experience multiple hops between two end UEs may be referred to as a multi-hop (MH) U2U network.

### SUMMARY

The systems, methods, and devices of this disclosure each have several innovative aspects, no single one of which is solely responsible for the desirable attributes disclosed herein. The following is a summary of some non-limiting aspects of the disclosure:

A method for wireless communications by an apparatus is described. The method may include receiving, at a first UE associated with a UE-to-UE network, control information that indicates a UE-specific quantity of relays for communications of a second UE and performing one or more communications of the UE-to-UE network, at the first UE, in accordance with the UE-specific quantity of relays for communications of the second UE.

An apparatus for wireless communications is described. The apparatus may include a processing system that includes processor circuitry and memory circuitry that stores code. The processing system may be configured to cause the apparatus to receive, at a first UE associated with a UE-to-UE network, control information that indicates a UE-specific quantity of relays for communications of a second UE and perform one or more communications of the UE-to-UE network, at the first UE, in accordance with the UE-specific quantity of relays for communications of the second UE.

Another apparatus for wireless communications is described. The apparatus may include means for receiving, at a first UE associated with a UE-to-UE network, control information that indicates a UE-specific quantity of relays for communications of a second UE and means for performing one or more communications of the UE-to-UE network, at the first UE, in accordance with the UE-specific quantity of relays for communications of the second UE.

A non-transitory computer-readable medium storing code for wireless communications is described. The code may include instructions executable by one or more processors to receive, at a first UE associated with a UE-to-UE network, control information that indicates a UE-specific quantity of relays for communications of a second UE and perform one or more communications of the UE-to-UE network, at the first UE, in accordance with the UE-specific quantity of relays for communications of the second UE.

In some examples of the method, apparatus, and non-transitory computer-readable medium described herein, the UE-specific quantity of relays for communications of the second UE may be different from a threshold quantity of relays associated with the UE-to-UE network.

In some examples of the method, apparatus, and non-transitory computer-readable medium described herein, performing the one or more communications of the UE-to-UE network may include operations, features, means, or instructions for incrementing a value of a relay count field of the control information based on the value of the relay count field being less than the UE-specific quantity of relays and transmitting a discovery information message including an entry associated with the second UE, where the entry indicates the incremented value of the relay count field.

In some examples of the method, apparatus, and non-transitory computer-readable medium described herein, performing the one or more communications of the UE-to-UE network may include operations, features, means, or instructions for decrementing the UE-specific quantity of relays indicated by the control information based on the UE-specific quantity of relays satisfying a threshold quantity of relays and transmitting second control information that indicates the decremented UE-specific quantity of relays.

A method for wireless communications by an apparatus is described. The method may include transmitting, from a UE, control information that indicates a UE-specific quantity of relays for communications of the UE via a UE-to-UE network and performing one or more communications via the UE-to-UE network in accordance with the UE-specific quantity of relays for communications of the UE.

An apparatus for wireless communications is described. The apparatus may include a processing system that includes processor circuitry and memory circuitry that stores code. The processing system may be configured to cause the apparatus to transmit, from a UE, control information that indicates a UE-specific quantity of relays for communications of the UE via a UE-to-UE network and perform one or more communications via the UE-to-UE network in accordance with the UE-specific quantity of relays for communications of the UE.

Another apparatus for wireless communications is described. The apparatus may include means for transmitting, from a UE, control information that indicates a UE-specific quantity of relays for communications of the UE via a UE-to-UE network and means for performing one or more communications via the UE-to-UE network in accordance with the UE-specific quantity of relays for communications of the UE.

A non-transitory computer-readable medium storing code for wireless communications is described. The code may include instructions executable by one or more processors to transmit, from a UE, control information that indicates a UE-specific quantity of relays for communications of the UE via a UE-to-UE network and perform one or more communications via the UE-to-UE network in accordance with the UE-specific quantity of relays for communications of the UE.

Some examples of the method, apparatus, and non-transitory computer-readable medium described herein may further include operations, features, means, or instructions for setting the UE-specific quantity of relays based on one or more of a threshold latency associated with the UE, a service type associated with the UE, or other parameters associated with the UE.

In some examples of the method, apparatus, and non-transitory computer-readable medium described herein, transmitting the control information may include operations, features, means, or instructions for transmitting a link establishment message that indicates the UE-specific quantity of relays for communications of the UE.

In some examples of the method, apparatus, and non-transitory computer-readable medium described herein, transmitting the control information may include operations, features, means, or instructions for transmitting a link modification message or an identifier (ID) update message, where the link modification message or the ID update message includes the UE-specific quantity of relays for communications of the UE.

### BRIEF DESCRIPTION OF THE DRAWINGS

FIG. 1 shows an example of a wireless communication system.

FIGS. 2 through 4 show examples of communication configurations that support device-specific hop limits for relay handling.

FIG. 5 shows a block diagram of a processing system that supports device-specific hop limits for relay handling.

FIG. 6 shows a diagram of a system including a device that supports device-specific hop limits for relay handling.

FIGS. 7 and 8 show flowcharts illustrating methods that support device-specific hop limits for relay handling.

Details of aspects and advantages of the subject matter in this disclosure are set forth in the drawings and accompanying descriptions. Like reference numbers and designations in the various drawings indicate like elements.

### DETAILED DESCRIPTION

A communication system may include a radio access network (RAN) that supports wireless communication. Communication of a RAN may be performed in accordance with one or more radio access technologies (RATs), including 4G, 5G, or 6G, among others, including technologies not explicitly mentioned herein. A RAT may employ access technologies (such as multiplexing technologies) including code division multiple access (CDMA), time division multiple access (TDMA), frequency division multiple access (FDMA), orthogonal FDMA (OFDMA), single-carrier FDMA (SC-FDMA), time division synchronous code division multiple access (TD-SCDMA), or discrete Fourier transform spread orthogonal frequency division multiplexing (DFT-S-OFDM), among others. A RAT may support one or more service types, including machine type communication (MTC), massive MTC (mMTC), Internet of Things (IoT), narrowband IoT (NB-IoT), reduced capability (RedCap), enhanced mobile broadband (eMBB), ultra-reliable low-latency communication (URLLC), or public safety, among others.

To support these and other target verticals, a communication system (such as a RAN) may be designed to implement one or more of a modularized functional infrastructure, a disaggregated and service-based network architecture, network function virtualization, network slicing, multi-access edge computing, spatial processing or multipath techniques, IoT or RedCap device connectivity and management, industrial connectivity, licensed and unlicensed spectrum access, sidelink or other device-to-device (D2D) direct communication (such as vehicle-to-everything (V2X)), frequency spectrum expansion, overlapping spectrum use, small cell deployments, non-terrestrial network (NTN) deployments, device aggregation, advanced duplex communication (such as sub-band full-duplex (SBFD)), multiple-subscriber implementations, high-precision positioning, radio frequency (RF) sensing, network energy savings (NES), low-power signaling and radios, or artificial intelligence or machine learning (AI/ML), among other examples.

The foregoing and other technological improvements may support use cases such as voice calls, messaging, data transfer, streaming, wireless data centers, extended reality (XR) and metaverse applications, vehicle connectivity, holographic and mixed reality communication, autonomous and collaborative robots, sensing networks, gesture monitoring, human-brain interfacing, digital twin applications, asset management, and universal coverage using non-terrestrial or aerial platforms, among other examples. As the demand for connectivity continues to increase, further improvements may be implemented, and other RATs, including 6G and beyond, may be introduced to enable new applications and use cases. The systems, methods, and devices described herein may enable one or more of the foregoing technologies or new technologies or support one or more of the foregoing use cases or new use cases.

Some wireless communication systems may include a user equipment (UE)-to-UE network, such as a mobile ad-hoc network (MANET), which may include a set of UEs that support relaying information from one end UE to another end UE without direct intervention from a network entity. For example, if an end UE is unable to connect with the network entity, the end UE may establish a link with the MANET and may communicate with one or more other end UEs or a network entity via the MANET. In some cases, a communication from a first end UE may be relayed one or more times between various UEs associated with the MANET, and each instance of relaying the communication may be referred to as a hop. For example, if a first end UE transmits a communication to a relay UE of the MANET (e.g., a first hop), and the relay UE transmits the communication to a second end UE (e.g., a second hop), there are two hops between the first end UE and the second end UE for the communication. In some cases, a MANET hop limit may be a threshold quantity of hops associated with the MANET (e.g., configured for the MANET, configured for all UEs of a MANET), such that communications may not be relayed within the MANET more times than the MANET hop limit. However, a MANET hop limit may not be configured to support latency targets for some communication (e.g., low-latency communication), including some UE-specific communication. Additionally, a MANET may relay (e.g., propagate) some communications associated with an end UE (e.g., discovery communications, configuration communications) over more hops than necessary to support some communications of a UE (e.g., propagating discovery information over more relays than necessary to support a latency target of an end UE)

Aspects of the subject matter described in this disclosure relate to implementing device-specific hop limits for relay handling within a wireless communications system. For example, an end UE may be configured to set a UE-specific hop limit (e.g., a UE-specific quantity of relays), which may be a threshold quantity of relays associated with a MANET for communications of (e.g., to, from) the end UE. In some implementations, a first UE (e.g., an end UE, a relay UE of the MANET) may transmit control information that indicates a UE-specific hop limit to a second UE associated with a MANET (e.g., a relay UE), and the first UE, the second UE, or both, may perform one or more communications via the MANET in accordance with (e.g., as a function of) the UE-specific hop limit. For example, the first UE may set the UE-specific hop limit based on one or more of a latency threshold, a service associated with the first UE, or another parameter associated with the UE. In some cases, the first UE may transmit the control information during a link establishment procedure, a link modification procedure, an identifier (ID) update procedure, or any combination thereof. The first UE may transmit (e.g., broadcast) the control information within an entry (e.g., a discovery entry) of a discovery information message. In some cases, a relay UE that receives the control information may reference the UE-specific hop limit and determine whether or not to forward (e.g., broadcast, transmit) the control information to one or more other UEs (e.g., relay UEs of the MANET, end UEs associated with the MANET). For example, the discovery information message may include one or more of a hop count field, the UE-specific hop limit, or other parameters. If the hop count field, the UE-specific hop limit, or both satisfy respective thresholds, a relay UE may increment the hop count field, decrement the UE-specific hop limit, or both, and may forward the control information with the incremented hop count field, the decremented UE-specific hop limit, or both. In some cases, control information from multiple UEs may be shared in a single discovery information message or in separate discovery information messages.

Particular aspects of the subject matter described in this disclosure can be implemented to realize one or more of the following potential advantages. In one example, a MANET applying UE-specific hop limits may reduce communications of control information beyond the UE-specific hop limit, which may reduce power usage and communication resource usage by the relay UEs of the MANET. Additionally, a MANET that implements UE-specific hop limits in accordance with techniques described herein may provide communications between end UEs more reliably within a threshold latency associated with a service or threshold latency associated with the end UEs.

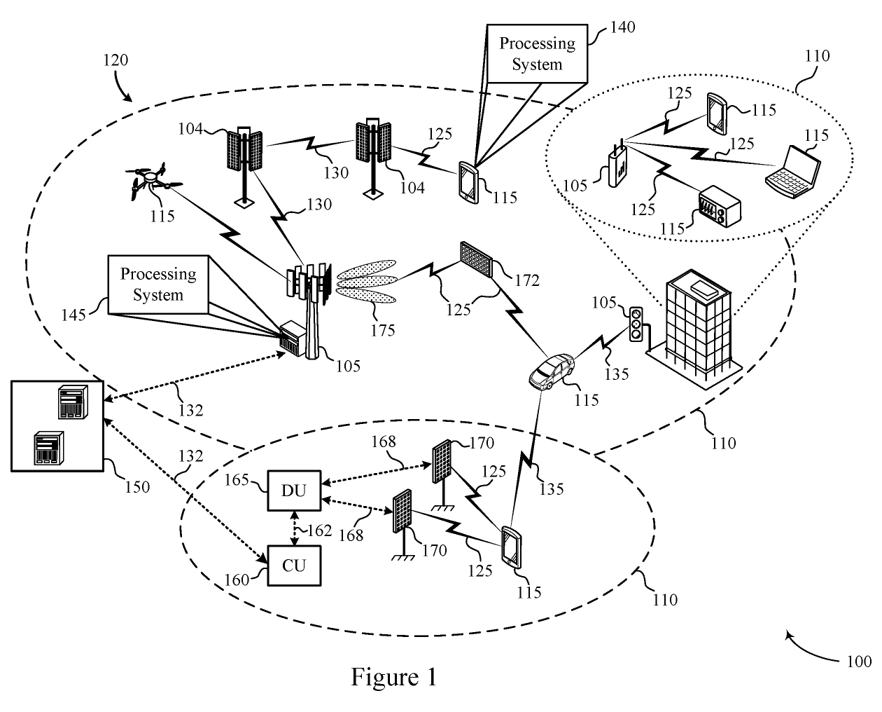

FIG. 1 shows an example of a wireless communication system 100. The wireless communication system 100 includes a core network 150 and a RAN 120 that support communication with one or more devices, such as UEs 115. A RAN 120 may include one or more network entities 105 configured to support wireless communication with the UEs 115.

The wireless communication system 100 may support communication among network entities 105 and UEs 115 in accordance with a layered protocol stack. For example, in a user plane, communication at a bearer layer, a Packet Data Convergence Protocol (PDCP) layer, or Service Data Adaption Protocol (SDAP) layer may be Internet Protocol (IP)-based. A Radio Link Control (RLC) layer may perform packet segmentation and reassembly to communicate via logical channels. A Medium Access Control (MAC) layer may perform priority handling and multiplexing of logical channels into transport channels. A MAC layer also may implement error detection techniques, error correction techniques, or retransmissions. In a control plane, a Radio Resource Control (RRC) layer may provide establishment, configuration, and maintenance of an RRC connection between UEs 115 and a network entity 105 or a core network 150, supporting radio bearers for user plane data. A Physical (PHY) layer may map transport channels to physical channels.

A core network 150 may support user authentication, access authorization, tracking, IP connectivity, and other access, routing, or mobility functions (such as via network entities 105). A core network 150 may be a 5G core (5GC) or 6G core (6GC), and may include at least one control plane entity that manages access and mobility and at least one user plane entity that routes packets or interconnects to external networks (such as a serving gateway (S-GW), a Packet Data Network (PDN) gateway (P-GW), a user plane function (UPF)).

A network entity 105 may support wireless communication in accordance with one or more coverage areas 110, and may be referred to as a network element, a network node, a RAN node, or network equipment, among other nomenclature. One or more of the network entities 105 may include or may be referred to as a base station. Depending on its capabilities, a base station may be referred to as a NodeB, an eNodeB (eNB), a next-generation NodeB or giga-NodeB (either of which may be referred to as a gNB), a 5G NB, a 6G NB, a next-generation eNB (ng-eNB), a Home NodeB, a Home eNodeB, or other suitable terminology. The wireless communication system 100 may include a heterogeneous network in which different types of network entities 105 support communication for one or more coverage areas 110 using the same or different RATs.

In some examples, a network entity 105 may be implemented in an aggregated (such as monolithic, standalone) architecture, which may utilize a protocol stack that is physically or logically integrated within one network entity 105 (such as a single physical RAN node). In some other examples, a network entity 105 may be implemented in a disaggregated architecture, which may utilize a protocol stack that is physically or logically distributed among multiple network entities 105, including in an integrated access and backhaul (IAB) network, an open RAN (O-RAN), or a virtualized RAN (vRAN). In a disaggregated architecture, a network entity 105 may include or be referred to as one or more of a central unit (CU) (such as CU 160), a distributed unit (DU) (such as DU 165), a radio unit (RU) (such as RU 170), or a combination thereof. The wireless communication system 100 may also implement a service-based architecture that provides a modular framework in which control plane functionality and common data repositories may be delivered through a set of interconnected network functions (NFs) that may access services of other NFs.

UEs 115 may be located in a coverage area 110 of one or more network entities 105, and may include or be referred to as an access terminal, a mobile station, a client device, or a subscriber unit. A UE 115 may be, include, or be coupled with a cellular phone, a wireless modem, a tablet device, a laptop computer, a wireless local loop (WLL) station, a camera, a medical or biometric device, a wearable device, a gaming device, an entertainment device, an XR device, a vehicular component or sensor, a smart meter or sensor, industrial manufacturing equipment, a Global Positioning System (GPS) or other positioning device, a robot or other device implementing artificial intelligence, a UE function of a network node, or any other wireless communication device or function that may communicate using a wireless medium.

The wireless communication system 100 may support various types of communication links among devices. For example, wireless communication between a network entity 105 and a UE 115 may be supported using one or more of a communication link 125 (such as a Uu interface), which may include downlink communication from a network entity 105 to a UE 115, uplink communication from a UE 115 to a network entity 105, or both. Direct wireless communication between UEs 115 may be supported using a communication link 135 (such as a device-to-device (D2D) communication link, a sidelink, a PC5 interface).

Communication between a network entity 105 and a core network 150 may be supported using a backhaul link 132 (such as an S1, N2, N3, NG, or other interface). In some implementations, communication between network entities 105 may be supported using a backhaul link 132 (such as an X2, Xn, or other interface) either directly (such as directly between network entities 105) or indirectly (such as via a core network 150). In some implementations (such as in a disaggregated architecture), communication between a CU 160 and a DU 165 may be supported using a midhaul link 162, and communication between a DU 165 and an RU may be supported using a fronthaul link 168. A backhaul link 132, a midhaul link 162, a fronthaul link 168, or any combination thereof may be or include one or more wired links (such as an electrical link, an optical fiber link) or one or more wireless links (such as a radio link, a wireless optical link), among other examples or combinations thereof. Wireless backhaul, midhaul, or fronthaul may be implemented via one or more IAB nodes 104, which may act as a relay using resources of an IAB donor network entity 105 (such as via a wireless link 130).

The wireless communication system 100 may include one or more of a relay 172 that may steer or reflect signals transmitted by other entities, which may support any of the described communication links. A relay 172 may include active elements or passive elements, and may be in the form of a reconfigurable intelligent surface (RIS). An RIS may include tunable reflecting antenna arrays or metasurfaces, which may be used to enhance coverage or efficiency in multipath environments.

Network entities 105 and UEs 115 each may include one or multiple antennas. Multiple antennas of such devices may be used to employ techniques such as transmit diversity, receive diversity, MIMO communication, or beamforming, and may be organized or structured as one or more antenna panels, one or more antenna groups, one or more sets of antenna elements, or one or more antenna arrays, among other examples. As used herein, the term “antenna” may refer to one or more antennas, one or more antenna panels, one or more antenna groups, one or more sets of antenna elements, or one or more antenna arrays. The term “antenna panel” may refer to a group of antennas (such as antenna elements) arranged in an array or panel, which may facilitate beamforming by manipulating parameters associated with the group of antennas. In some implementations, an antenna panel may support RF beamforming for a signal transmitted or received via an antenna port. The term “antenna module” may refer to circuitry including one or more antennas as well as one or more other components (such as filters, amplifiers, processors, beamformers) associated with integrating the antenna module into a device such as a network entity 105 or a UE 115.

Beamforming, such as directional transmission or directional reception, is a signal processing technique that may be used at a transmitting device or a receiving device (such as at a network entity 105, at a UE 115) to shape or steer a beam 175 (such as an antenna beam, a transmit beam, a receive beam) along a spatial path (such as along a direction), which may include one or more paths between a transmitting device and a receiving device. Beamforming may be achieved by combining signals communicated via multiple antenna elements of an antenna array such that signals propagating along some orientations (such as relative to the antenna array) experience constructive interference while others may experience destructive interference. Adjustments of signals communicated via the antenna elements may include a transmitting device or a receiving device applying phase offsets, amplitude offsets, or other adjustments to signals carried via (such as transmitted by, received by) antenna elements of the device, which may be defined by a beamforming weight set associated with a particular orientation (such as relative to the antenna array of the device).

Communication resources of the wireless communication system 100 (such as of a RAN 120) may refer to a resource in the frequency domain (such as a frequency resource, an RF resource), a resource in the time domain (such as a time resource), a resource in the spatial domain (such as a spatial resource, a spatial layer), or a combination thereof. The wireless communication system 100 may leverage orthogonality of such resources to convey different communications to or from different devices (such as for a communication link 125, for a communication link 135, for unicast communication, for multicast communication, for broadcast communication).

A frequency resource may refer to a frequency or range of frequencies (such as a bandwidth, a frequency channel) of a frequency band implemented for wireless communication. For example, a frequency resource may refer to a resource of a lower frequency band (such as Frequency Range 1 (FR1), between 425 MHz and 7.125 GHz), a mid-band (such as Frequency Range 3 (FR3), between 7.125 GHz and 24.25 GHz), or an upper frequency band (such as Frequency Range 2 (FR2), between 24.25 GHz and 71 GHz). Communication in the upper frequency band may be referred to as millimeter wave (mmW) communication, and communication above an upper frequency band (such as between mmW and THz frequencies, between 100 GHz and 1 THz) may be referred to as sub-Terahertz (sub-THz) communication.

A frequency resource may refer to a “carrier” (such as a frequency channel), or portion thereof, and a carrier bandwidth may be referred to as a “system bandwidth.” A carrier may be subdivided in the frequency domain, including into subcarriers, bandwidth parts (BWPs), or both. For example, a resource block (RB), such as a physical resource block (PRB), may be defined in accordance with a set of subcarriers (such as twelve consecutive subcarriers in the frequency domain), and a BWP may be configured in accordance with a set of RBs (such as a set of contiguous RBs).

A frequency resource may be configured to carry either downlink communication or uplink communication (such as in a frequency division duplexing (FDD) configuration), or may be configured to carry both downlink and uplink communication (such as in a time division duplexing (TDD) configuration, in a sub-band full duplex (SBFD) configuration). One or more numerologies for a carrier may be supported, each associated with a subcarrier spacing (SCS) and a cyclic prefix (CP). Supported numerologies may vary by frequency range (such as FR1, FR2, FR3), and a carrier may be divided into portions (such as BWPs) having the same or different numerologies. BWPs may be configured as uplink BWPs or downlink BWPs (such as by a network entity 105), including in response to network conditions (such as to allocate uplink and downlink BWPs in response to traffic conditions), device capability (such as allocating BWPs with a greater quantity of RBs to UEs 115 with relatively higher capabilities), or both. A UE 115 may be configured with a set of multiple BWPs (such as a set of uplink BWPs, a set of downlink BWPs, or both), and a single BWP of a set (such as an active UL BWP, an active DL BWP, or both) may be active at a given time, such that communication of a UE 115 is supported by active BWP(s).

A time resource may refer to a duration of a frame (such as a radio frame, a frame structure), or portion thereof. For example, a frame may span a duration of 10 ms, and each frame may be identified by a system frame number (SFN). A frame may be subdivided in the time domain, including into subframes, slots, mini-slots, or a combination thereof. Slots or mini-slots may each include a respective quantity of symbols (such as symbol durations, symbol periods, OFDM symbols), which may be a function of a configured CP. A duration of a symbol is a function of the SCS or frequency band of operation.

A spatial resource may refer to an antenna, an antenna direction, an antenna port, a signal direction (such as a beamforming direction), or other resource that supports spatial orthogonality. A device (such as a network entity 105, a UE 115) may perform communications of a given frequency resource and time resource with a single spatial resource (such as communication without regard to spatial orthogonality). Additionally, or alternatively, a device may implement multiple spatial resources to support multiple signal streams using resources that are overlapping in the time and frequency domains (such as to support MIMO techniques).

Signals of the wireless communication system 100 (such as of a RAN 120) may be communicated using one or more resource elements (REs), and an RE may refer to a resource that corresponds to one subcarrier in the frequency domain and one symbol in the time domain. An RE may be used to convey a modulation symbol corresponding to one or more bits of information (such as of a physical channel, of a reference signal) in accordance with a modulation scheme. For example, a quadrature phase shift keying (QPSK) or quadrature amplitude modulation (QAM) technique may be implemented to communicate one or more bits that are distinguished in accordance with phase components, amplitude components, or both of a signal conveyed using a RE. A quantity of bits carried by an RE may depend on an order of the modulation scheme, and a relatively higher order may correspond to a relatively higher rate of communication. A device may support communication of REs using multiple subcarriers concurrently by implementing multi-carrier modulation (MCM) techniques such as orthogonal frequency division multiplexing (OFDM) or discrete Fourier transform spread OFDM (DFT-S-OFDM), among others.

Physical channels may carry information using modulation symbols conveyed by corresponding REs. Physical shared channels (such as for communicating user data) may include a physical downlink shared channel (PDSCH) for communicating user data in a downlink direction and a physical uplink shared channel (PUSCH) for communicating user data in an uplink direction. Physical control channels (such as for managing communication via physical channels) may include a physical downlink control channel (PDCCH) for communicating downlink control information (DCI) and a physical uplink control channel (PUCCH) for communicating uplink control information (UCI). A network entity 105 may indicate (such as schedule, allocate) communication resources for a UE 115 using DCI, including indicating downlink resources of a PDSCH (such as in accordance with a downlink grant), uplink resources of a PUSCH (such as in accordance with an uplink grant), or a combination thereof. A control region (such as a control resource set (CORESET)) for a physical control channel may be configured in accordance with a pattern of REs in the time and frequency domains, and one or more control regions may be configured for a set of UEs. A UE 115 may monitor control regions for control information according to one or more search space sets, which may include a common search space set (such as for sending control information to one or more UEs 115), UE-specific search space sets (such as for sending control information to a UE 115), or a combination thereof. A physical broadcast channel (PBCH) may be used to broadcast parameters to UEs 115 to synchronize with a network entity 105 and establish communications (such as to establish a communication link 125).

Reference signals may be communicated to establish reference characteristics (such as a frequency reference, a temporal reference, a spatial reference, a signal quality reference) between devices of a RAN 120, which may support communication using physical channels. Reference signals communicated between network entities 105 and UEs 115 may include synchronization signals (such as a primary synchronization signal (PSS), a secondary synchronization signal (SSS)) that support temporal synchronization, channel state information-reference signals (CSI-RSs) that support evaluating downlink channel characteristics, sounding reference signals (SRSs) that support evaluating uplink channel characteristics, demodulation reference signals (DMRSs) that support demodulation, or phase tracking reference signals (PTRSs) for evaluating oscillator characteristics, among others. Network entities 105 and UEs 115 may receive and measure transmitted reference signals to support one or more of these and other functions.

Devices of the wireless communication system 100 may be configured to support one or more aspects of the described techniques for device-specific hop limits for relay handling. For example, a UE 115 may include a processing system 140, and a network entity 105 may include a processing system 145, each of which may be configured to cause the respective device to perform (such as being configured as means for performing) one or more of the described operations. By configuring a processing system 140, a processing system 145, or a combination thereof in accordance with the described techniques, the communication system 100 may support device-specific hop limits for communications within a UE-to-UE network. Such techniques may support efficient utilization of communication resources and improve communication performance by limiting quantities of relays for communications for each specific UE, which may support various UE-specific or service-specific communication parameters (e.g., latency targets, reliability targets).

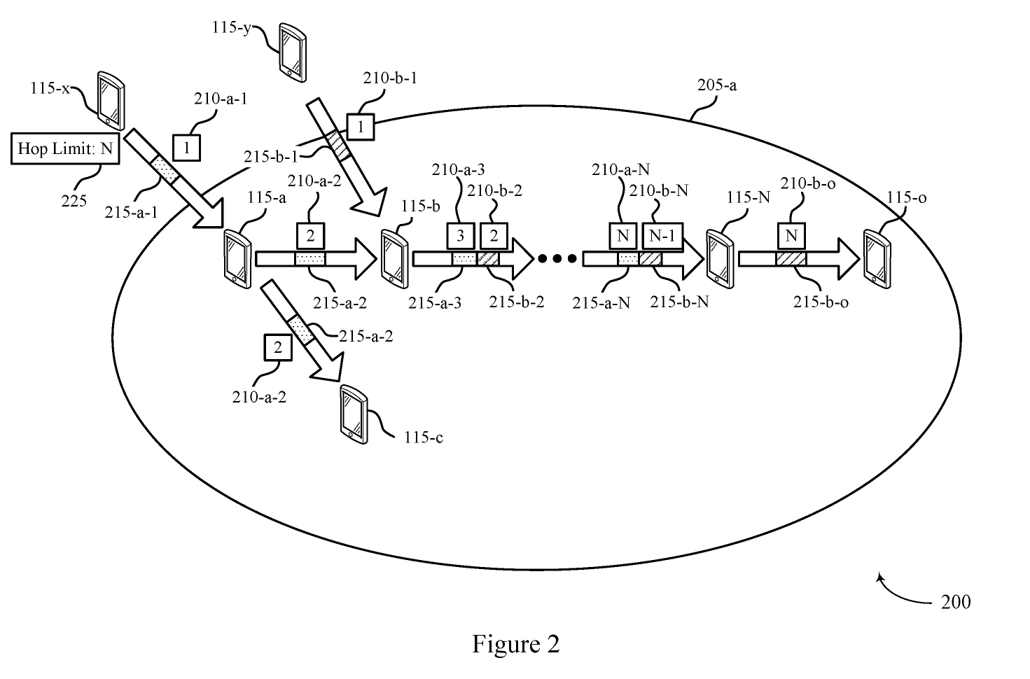

FIG. 2 shows an example of a communication configuration 200 that supports device-specific hop limits for relay handling. Aspects of the communication configuration 200 (e.g., a UE-to-UE communication system) may implement or be implemented by aspects of a communication system 100. For example, the communication configuration 200 includes UEs 115, which may be examples of the UEs 115 described herein, and a network 205-a, which may be an example of a UE-to-UE network (e.g., a MANET).

Some wireless communication systems may support UE-to-UE network functionalities (e.g., IP-based MANET functionalities), such as those utilized by the network 205-a. For example, one or more UEs 115 may establish a link with one another to form the network 205-a, and may assume the role of a router (e.g., a MANET router). A UE 115 within the network 205-a performing actions of a router may be referred to as a relay UE 115 (e.g., a UE-to-UE (U2U) relay UE). For example, the UEs 115-a. 115-b, 115-N, 115-o, and one or more other UEs 115 may be relay UEs 115 of the network 205-a. An end UE 115 may be a UE 115 that is an initial transmitter or intended receiver of a given instance of communication via the network 205-a. In some cases, UEs 115-x and 115-y may be end UEs 115. Additionally, or alternatively, a relay UE 115 within the network 205-a may be an end UE 115 in some scenarios, and vice versa.

To join the network 205-a, a UE 115 may perform a discovery procedure. In some examples of a discovery procedure, a UE 115 of the network 205-a (e.g., a relay UE 115, the UE 115-a) may send (e.g., broadcast, transmit) an announcement message, and the UE 115-x (e.g., outside of the network 205-a, before joining the network 205-a) may receive the announcement message and discover the relay UE 115. For example, the announcement message may include a user info ID of the relay UE 115, an RSC associated with the network 205-a, or both. In some other examples of the discovery procedure, an end UE 115 (e.g., UE 115-x) may send (e.g., broadcast, transmit) a discovery solicitation message, and a UE 115 of the network 205-a (e.g., a relay UE 115) that receives the discovery solicitation message (e.g., the UE 115-a) may respond with an announcement message or another message identifying the relay UE and the network 205-a.

After discovery, the end UE (e.g., UE 115-x) and the relay UE 115 (e.g., UE 115-a) may establish a direct link (e.g., a communication link 135, a PC5 direct link connection) via a direct link connection procedure. For example, during the discovery procedure, the direct link establishment procedure, or both, the UE 115-x may share an instance of control information 215(e.g., control information 215-a-1) with the UE 115-a, and the instance of control information 215 may include an IP address of the UE 115-x, an application layer ID of the UE 115-x, or both. The UE 115-a may broadcast a discovery information message to other relay UEs of the network 205-a, and the discovery information message may include another instance of control information 215 (e.g., including relayed control information). In some cases, a discovery information message may include one or more entries (e.g., a discovery entry, a list of entries), and an entry may include the control information 215 associated with the UE 115-x.

In some cases, each UE 115 of the network 205-a that receives the control information 215 may store the control information 215 at relay UE 115 to provide IP connectivity to UEs 115 linked to the network 205-a. Additionally, a UE 115 of the network 205-a may generate a discovery information message including an entry for the control information 215, and may broadcast (e.g., forward, transmit) the discovery information message to other UEs 115 until some or all of the relay UEs 115 of the network 205-a store the same control information 215 for the UE 115-x. Such propagating or sharing of discovery information messages allows the UEs 115 within the network 205-a to provide IP connectivity to end UEs 115.

For example, after joining the network 205-a, the UE 115-x (e.g., an end UE 115) may discover other UEs 115 (e.g., other end UEs 115) by querying a UE 115 (e.g., the UE 115-a) of the network 205-a using a domain name system (DNS) associated with the network 205-a. For example, the UE 115-x may transmit a query to the UE 115-a that indicates an application layer ID of another UE 115 (e.g., a potential end UE 115 the UE 115-y, another relay UE). The UE 115-a may respond to the query with a message that indicates an IP address of the other UE 115 based on the application layer ID if the other UE 115 is associated with the network 205-a. The UE 115-x may then communicate with the other UE 115 via IP connectivity (e.g., using the network 205-a, using other IP communication methods).

In some cases, a hop limit associated with the network 205-a (e.g., a hop limit applied to all communications of the network 205-a, a hop limit common to all UEs 115 of the network 205-a, a network-wide hop limit, a MANET hop limit) may limit a quantity of relays performed on a single communication within the network 205-a. For example, a MANET hop limit may be a threshold quantity of relays (e.g., hops) that a communication is permitted to perform across the UEs 115 of the network 205-a. In some implementations, each MANET (including the network 205-a) may be associated with a relay service code (RSC), and each UE 115 of the MANET may be configured with the RSC of the associated MANET. In some cases, a UE 115, a network entity 105, or another entity or device may configure the RSC, the hop limit, or both, for a MANET.

In some cases, each act of communicating a message (e.g., control information 215, a data communication, a communication relay) may be referred to as a hop, such that the communication of control information 215 from the UE 115-x to the UE 115-a may be a first hop, the communication of control information 215 (e.g., relayed control information 215) from the UE 115-a to the UE 115-b may be a second hop, and so on until the communication of control information 215 to the UE 115-N is an Nth hop. In some cases, transmitting a communication into the network 205-a (e.g., from UE 115-x to UE 115-a), receiving a communication out of the network 205-a (e.g., from UE 115-b to UE 115-y), or both, may not count as a relay or hop with respect to a hop limit (e.g., a MANET hop limit or other hop limit).

In accordance with examples as disclosed herein, a UE 115 (e.g., associated with the network 205-a) may set a UE-specific hop limit 225, which may be different than (e.g., less than) a hop limit associated with the network 205-a (e.g., a network-wide hop limit, a MANET hop limit). For example, a UE-specific hop limit 225 may be a threshold quantity of relays that the network 205-a may perform on a communication that is for the associated UE 115 (e.g., communicated to or from the associated UE 115, as an end UE 115). In an example of such techniques, the UE 115-x may set a corresponding UE-specific hop limit 225 based on one or more of services requested at the UE 115-x, a threshold latency associated with the UE 115-x, or other criteria or parameters associated with the UE 115-x. In some cases, a relatively low hop limit (e.g., 2 hops) may support lower latency (e.g., and thus support quicker services) than a relatively high hop limit. For example, for an end UE 115 to perform a lower-latency service, the end UE 115 may set the UE-specific hop limit 225 to a low quantity (e.g., 2 hops) to maintain a relatively low delay budget of the lower-latency service. In some other examples (e.g., for different services, concurrently or at different times), the end UE 115 may set the UE-specific hop limit 225 to a relatively higher quantity (e.g., 5 hops), such as to support a more delay-tolerant service. Accordingly, a UE-specific hop limit 225 may depend on services requested or performed by an end UE 115. However, in some implementations, the UE-specific hop limit 225 may not be greater than the MANET hop limit (e.g., a threshold hop limit for the network 205-a).

In some aspects, one or more end UEs 115 (e.g., a UE 115-x, a UE 115-y) may transmit an instance of control information 215 (e.g., control information 215-a-1, control information 215-b-1) to a relay UE (e.g., a UE 115-a, a UE 115-b) of the network 205-a (e.g., a UE-to-UE network, a MANET). The control information 215 may include a UE-specific hop limit, and one or more relay UEs 115 of the network 205-a (e.g., the UE 115-a, a UE 115-b, a UE 115-N, a UE 115-o) may relay the control information and other communications based on (e.g., in accordance with) the UE-specific hop limit. In some wireless communications systems, relay UEs 115 within a MANET may not be configured to apply UE-specific hop limits 225 differently than a MANET hop limit. Additionally, or alternatively, a MANET may not be configured with a procedure to set UE-specific hop limits 225 and limit the sharing of control information 215 (e.g., discovery information) in accordance with the UE-specific hop limits 225. For example, relay UEs 115 of a MANET may not be made aware of UE-specific hop limits 225 set by each end UE 115. Additionally, or alternatively, relay UEs 115 may not consider a UE-specific hop limit 225 for sharing control information 215, and may not be configured with techniques for propagating updates to the control information 215 for a UE 115 based on a respective UE-specific hop limit 225. Such deficiencies may limit the utility of UE-specific hop limits 225 within a MANET.

In some cases, if a relay UE 115 of the network 205-a does not consider a UE-specific hop limit 225 when transmitting the control information 215 (e.g., forwarding control information, such as forwarding discovery information) within the network 205-a, control information 215 (e.g., discovery info) associated with an end UE 115 (e.g., the UE 115-x) may be shared with other UEs 115 of the network 205-a outside of a UE-specific hop limit 225 associated with the end UE 115. For example, if a MANET hop limit is large (e.g., unlimited), discovery information may be shared with relay UEs 115 that are far away from an end UE 115 and are associated with reduced communication quality or higher latency (e.g., an impractical delay) when communicating with the end UE 115. Additionally, or alternatively, if a MANET hop limit is a relatively moderate quantity of hops, a service requested by the UE 115-x may have a low latency threshold, such that the MANET hop limit may be larger than the UE-specific hop limit 225 for the UE 115-x, leading to wasted resources and increased latency from excessive sharing the control information 215.

In accordance with examples as disclosed herein, UEs 115 of the network 205-a (e.g., relay UEs 115) may be configured with techniques for receiving, sharing, and utilizing UE-specific hop limits 225. For example, one or more UEs 115 (e.g., the UE 115-a, the UE 115-b, the UE 115-N, the UE 115-o, one or more other UEs 115) may perform a discovery procedure and establish direct links (e.g., communication links 135) with one another to form the network 205-a. In some cases, the UE 115-x may not initially be associated with the network 205-a. The UE 115-a may broadcast an announcement message (e.g., a discovery message) as part of a discovery procedure, and the announcement message may include a user info ID of the UE 115-a, an RSC associated with the network 205-a, or both. The UE 115-x may monitor for the announcement message and, after (e.g., in response to) receiving the announcement message, may determine if the network 205-a is a newly discovered MANET based on the RSC. Additionally, or alternatively, the UE 115-x may transmit a discovery solicitation message to begin a discovery procedure, in accordance with examples as disclosed herein.

In some examples, if the network 205-a is a newly discovered network to the UE 115-x, the UE 115-x may perform a direct link establishment procedure with the UE 115-a to join the network 205-a (e.g., or to form the network 205-a if no other UEs 115 are within the network 205-a yet). During the direct link establishment procedure, the UE 115-x may transmit control information 215-a-1 to the UE 115-a in a direct link establishment message (e.g., as part of establishing a communication link 135, using a communication link 135). The control information 215-a-1 may include a UE-specific hop limit 225 for the UE 115-x and, in some examples, an application layer ID of the UE 115-x, an IP address of the UE 115-x, or both, among other examples of identifying information. The UE-specific hop limit 225 may be set by the UE 115-x based on one or more of a latency threshold associated with the UE 115-x, a service associated with the UE 115-x, or other parameters associated with the UE 115-x. Additionally, or alternatively, the UE 115-x may transmit the control information 215-a-1 to the UE 115-a in a link modification message during a direct link modification procedure (e.g., to modify aspects of a communication link 135 or service thereof), in an ID update message during an ID update procedure, or a combination thereof. After the direct link is established between the UE 115-x and the UE 115-a, the UE 115-x may use the direct link modification procedure or the ID update procedure to update the application layer ID, IP address, or UE-specific hop limit 225 associated with the UE 115-x.

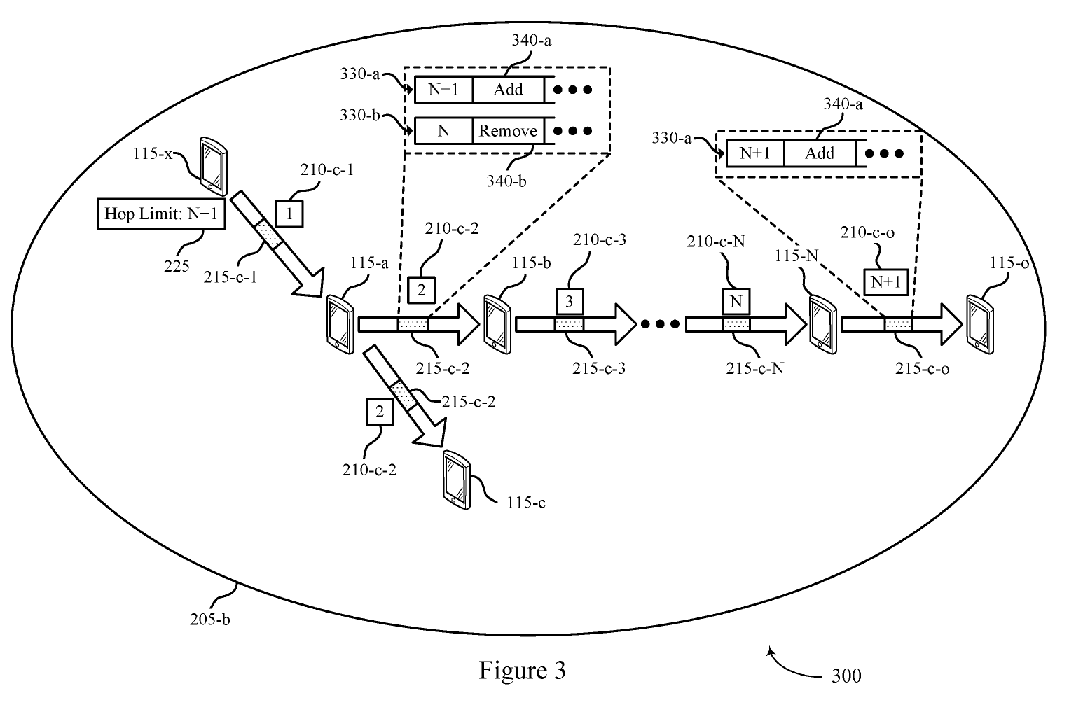

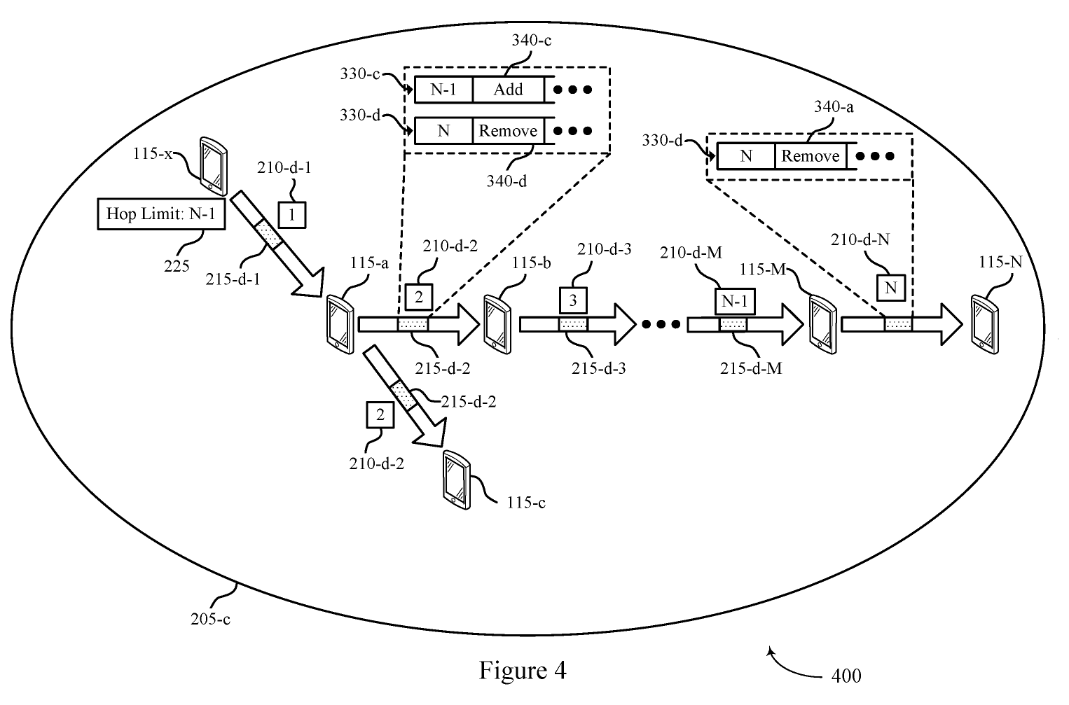

After receiving the control information 215-a-1, the UE 115-a may store at least a portion of the information indicated by the control information 215-a-1, and may trigger message signaling (e.g., a discovery information procedure) within the network 205-a. For example, the UE 115-a may transmit (e.g., broadcast) control information 215-a-2 (e.g., forwarded control information 215-a-1, forwarding one or more indications of the control information 215-a-1) to one or more other relay UEs 115 of the network 205-a (e.g., UE 115-b-1, UE 115-b-2, other relay UEs). In some cases, the UE 115-x, the UE 115-a, or both may generate a discovery information message (e.g., a MANET discovery information message) to carry the control information 215-a-1, the control information 215-a-2, or both. In some cases, the discovery information message may include one or more entries (e.g., discovery entries), for which each entry may be associated with a respective UE 115 and may include control information associated with the respective UE 115, such as the IP address, the app layer ID, the UE-specific hop limit 225, a status bit associated with the entry (e.g., as described with reference to FIGS. 3 and 4), or any combination thereof. If the UE 115-x has not set a UE-specific hop limit 225 or the control information 215-a-1 does not indicate a UE-specific hop limit 225, the UE 115-a may add the MANET hop limit associated with the network 205-a to the control information 215-a-2 in place of a UE-specific hop limit associated with the UE 115-x.

In some implementations, each discovery information message (e.g., an example or of including control information 215) may include a list of entries (e.g., discovery entries), and each entry may correspond to a respective UE 115. In some examples, more than one entry may correspond to a UE 115. Each entry in a discovery information message may include information (e.g., the control information 215) associated with a corresponding UE 115. For example, each discovery entry may include a UE-specific hop limit 225, an entry status (e.g., add, update, remove), an application layer ID, an IP address, or any combination thereof.

In one example, to refrain from propagating indications of (e.g., discovery information of) control information 215 past a UE-specific hop limit 225, each entry in a discovery information message may include a hop count field 210. For example, a header of the discovery information message may not include hop count fields 210 or UE-specific hop limits 225. Accordingly, in response to receiving a discovery information message, each relay UE 115 may determine if a hop count field 210 in each entry of the discovery information message satisfies, (e.g., is equal to, is greater than) a UE-specific hop limit 225 indicated in the entry, the MANET hop limit for the network 205-a, or both. If the hop count field 210 of an entry is below a UE-specific hop limit 225 and the MANET hop limit, the relay UE 115 may increment the hop count field 210 by one and generate a discovery information message that includes an entry for the control information 215 and the incremented hop count field 210. If a hop count field 210 of an entry is equal to (e.g., or greater than) a UE-specific hop limit 225 indicated in the entry, the MANET hop limit, or both, the relay UE 115 may store the control information 215 indicated in the entry, but may not generate a discovery information message for the entry, or may exclude the entry from a generated discovery information message. For example, a relay UE 115 may refrain from forwarding an entry if the hop count limit is greater than or equal to the UE-specific hop limit.

Accordingly, each UE 115 of the network 205-a that receives control information 215 within a UE-specific hop limit 225 may generate an updated discovery information message based on the received entries, and one or more entries with a hop count field 210 that is less than a UE-specific hop limit 225 indicated in the entry may be included in the discovery information message. As an example, the UE 115-x may transmit (e.g., broadcast, unicast) the control information 215-a-1, and the control information 215-a-1 may indicate a UE-specific hop limit 225 of a value N. In some cases, the control information 215-a-1 may include a hop count field 210-a-1 indicating an initial value (e.g., 1). The UE 115-a may receive the control information 215-a-1 and may determine if the hop count field 210-a-1 is below the UE-specific hop limit 225 indicated in the control information 215-a-1. If so, the UE 115-x may increment the hop count from the hop count field 210-a-1 (e.g., from 1 to 2), and may generate a discovery information message including an entry for control information 215-a-2 (e.g., a copy of control information 215-a-1) and a hop count field 210-a-2 (e.g., including the incremented hop count). In some cases, the control information 215-a-1 may not include the hop count field 210-a-1, and the UE 115-a may determine that the control information 215-a-1 is received from an end UE based on a message type that carries the control information 215-a-1. Accordingly, the UE 115-a may set the hop count field 210-a-2 to the initial value plus one.

After the UE 115-a broadcasts the generated discovery information message, the UEs 115-b and 115-c may receive the discovery information message including the incremented hop count field 210-a-2 from UE 115-a. Each of the UEs 115-b and 115-c may determine whether the hop count field 210-a-2 is less than the UE-specific hop limit 225 indicated in the entry of the discovery information message. If so, the UEs 115-b and 115-c may increment the hop count field 210-a-2 (e.g., to 3) and generate discovery information messages that include an entry for control information 215-a-3 (e.g., a copy of the control information 215-a-2) and the hop count field 210-a-3 (e.g., including the incremented hop count, incremented from 2 to 3).

Eventually, an Nth relay UE of the network 205-a, such as UE 115-N, may receive a discovery information message that includes an entry for control information 215-a-N (e.g., a copy of control information 215-a-1) and a hop count field 210-a-N. The UE 115-N may determine whether the hop count field 210-a-N is less than the UE-specific hop limit 225. If not, the UE 115-N may store at least a portion of the control information 215-a-N and may not include an entry for the control information 215-a-N in a generated discovery information message (e.g., or may not generate a discovery information message to propagate the control information 215-a-N). Accordingly, the control information 210-a-1 associated with the UE 115-x may not be propagated past the UE-specific hop limit 225 set by the UE 115-x.

In some other examples, to suppress propagation of control information (e.g., discovery information) past a UE-specific hop limit 225 of the UE 115-x, the UE 115-a may update the UE-specific hop limit 225 in forwarded control information. For example, if the UE-specific hop limit 225 indicated in the control information 215-a-1 is above a threshold (e.g., 0, 1), the UE 115-a may decrement (e.g., by one) the UE-specific hop limit 225 and transmit (e.g., broadcast) the control information 215-a-2 including the decremented UE-specific hop limit 225. Thus, if a relay UE 115 receives control information 215 with a UE-specific hop limit 225 that satisfies (e.g., is above) a threshold, the relay UE 115 may decrement the UE-specific hop limit 225 and generate a discovery information message including an entry for the control information 215 with the decremented UE-specific hop limit 225 (e.g., as well as discovery information, such as identification information associated with the originating end UE 115). If the UE-specific hop limit 225 indicated in the received control information 215 is equal to or below the threshold, the relay UE may not include an entry for the control information 215 in a discovery information message, or may not generate a discovery information message. Accordingly, the control information 215 of an end UE may not propagated to relay UEs past the UE-specific hop limit set by the end UE.

As an example, the UE 115-x may determine a UE-specific hop limit 225 of N, and may transmit (e.g., broadcast) the control information 215-a-1 including an indication of the UE-specific hop limit 225 (e.g., as generated at the UE 115-x). The UE 115-a may receive the control information 215-a-1 (e.g., via initial link establishment, link modification, or ID update) and may determine if the UE-specific hop limit 225 indicated by the control information 215-a-1 satisfies (e.g., is above) the threshold. If so, the UE 115-a may decrement the UE-specific hop limit 225 (e.g., to N-1) and generate a discovery information message that includes the control information 215-a-2, which may be a copy of the control information 210-a-1 with the decremented UE-specific hop limit 225. The UE 115-a may broadcast the discovery information message, which may be received by the UEs 115-b and 115-c. The UEs 115-b and 115-c may determine if the UE-specific hop limit 225 (e.g., N-1) indicated in the control information 215-a-2 satisfies (e.g., is greater than) the threshold. If so, the UE 115-b may further decrement the UE-specific hop limit 225 (e.g., to N-2) and generate a discovery information message with an entry for the control information 215-a-3, which may be a copy of the control information 215-a-2 with the further decremented UE-specific hop limit 225.

Eventually, the Nth relay UE 115 of the network 205-a, such as the UE 115-N, may receive the control information 215-a-N, which may indicate the UE-specific hop limit 225 having been decremented N-1 times (e.g., by the N-1 relay UEs 115 between the UE 115-N and the UE 115-x). The UE 115-N may determine that the decremented UE-specific hop limit 225 in the control information 215-a-N does not satisfy (e.g., is equal to or less than) the threshold. Accordingly, the UE 115-N may store the control information 215-a-N (e.g., including the decremented UE-specific hop limit 225) and may not include an entry for the control information 215-a-N in a discovery information message, or may not generate a discovery information message. Thus, control information 215 may propagate through the network 205-a until the UE-specific hop limit 225 is reached without adding extra overhead to the discovery information messages in the form of the hop count field 210.

In some cases, a single discovery information message may include entries associated with multiple different UEs 115. For example, the entries may include one or more entries for control information 215 forwarded from other relay UEs 115, one or more entries for control information 215 from end UEs (e.g., new or updated discovery information), or both. For example, a UE 115 of the network 205-a may receive a discovery information message including a list of entries, and may generate a discovery information message for broadcast that includes an updated list of entries to add entries for control information 215 that is received at the UE 115 (e.g., from an end UE). In some cases, the control information from an end UE 115 may update control information 215 associated with the end UE 115 or remove control information 215 associated with the end UE from the storage of one or more UEs 115. For example, the UE 115-b may receive a discovery information message from the UE 115-a that includes the control information 215-a-2 (e.g., associated with the UE 115-x). The UE 115-b may also receive control information 215-b-1 from the UE 115-y, which may indicate a UE-specific hop limit for the UE 115-y along with an application layer ID, an IP address, or both, associated with the UE 115-y. In some cases, the control information 215-b-1 may also include a hop count field 210-b-1. In accordance with the UE-specific hop limit for each instance of control information 215, the UE 115-b may generate a single discovery information message that includes a first entry for the control information 215-a-3 and a second entry for the control information 215-b-2.

The UEs 115 of the network 205-a may handle propagation of each entry (e.g., and the control information 215 therein) in a single discovery information message separately, as a function of respective UE-specific hop limits 225. For example, each UE 115 may include or exclude entries from a generated discovery information message in accordance with the UE-specific hop limit associated with the entry (e.g., indicated in the control information 215 in the entry). In some cases, a UE 115 of the network 205-a may apply the UE-specific hop limits 225 by incrementing a hop count field 210 in each entry, as described herein. Additionally, or alternatively, a UE 115 of the network 205-a may apply the UE-specific hop limits 225 by decrementing the UE-specific hop limit indicated in the control information 215 of each entry, as described herein. Accordingly, the UE 115-b may broadcast a discovery information message including an entry for the control information 215-a-3 and an entry for the control information 215-b-2 based on respective UE-specific hop limits 225, and the UE 115-N may broadcast a discovery information message including an entry for the control information 215-b-o while excluding an entry for the control information 215-a-N based on respective UE-specific hop limits 225.

In some cases, a UE 115 of the network 205-a may use separate discovery information messages for entries associated with different UEs 115. For example, a UE 115 may generate a discovery information message with an entry for control information 215 forwarded from other UEs 115, and may generate a discovery information message with an entry for control information received from an end UE 115. For example, the UE 115-b may receive the control information 215-a-2 from the UE 115-a in an entry of a discovery information message, and the UE 115-b may receive control information 215-b-1 from the UE 115-y (e.g., an end UE 115). In some cases, the UE 115-b may generate a first discovery information message that includes a single entry for the control information 215-a-3 and may generate a second discovery information message that includes a single entry for the control information 215-b-2. For example, the second discovery information message may include (e.g., only include) newly-available control information 215 for the UE 115-y (e.g., an end UE 115). For cases in which a UE 115 uses separate discovery information messages to forward control information 215 and to transmit new control information 215, the UE 115 may apply corresponding UE-specific hop limits 225 to each discovery information message by incrementing a hop count field 210 indicated in the discovery information message, by decrementing the UE-specific hop limits 225 indicated in the discovery information message, or both, as described herein.

In some cases, using separate discovery information messages to forward received control information 215 and to broadcast new control information 215 (e.g., updated control information) may allow each discovery information message to include a single entry. Accordingly, keeping track of a hop count field 210, a UE-specific hop limit 225, or both, for each discovery information message may be streamlined and use fewer processing resources. For example, each of the separate discovery information messages may include an indication of a corresponding UE-specific hop limit 225 or hop count field 210 in a header of the discovery information message.

Accordingly, a network 205-a may assist in UE-to-UE communication (e.g., discovery information forwarding and updating) in accordance with UE-specific hop limits 225. For example, UEs 115 of the network 205-a that are within a UE-specific hop limit 225 of a given end UE 115 (e.g., only such UEs 115) may be provided with and store control information such as discovery information, which may support an efficient distribution of such information and subsequent communications. Utilizing the UE-specific hop limits 225 in accordance with the communication configuration 200 may reduce communication resource utilization in the network 205-a, which may support reduced latency and improved reliability for UE-to-UE communications.

FIG. 3 shows an example of a communication configuration 300 that supports device-specific hop limits for relay handling. Aspects of the communication configuration 300 may implement or be implemented by aspects of a communication system 100 or a communication configuration 200. For example, the communication configuration 300 may include UEs 115 (e.g., of a network 205-b), which may be examples of the UEs 115 described herein. Additionally, the communication configuration 300 may include control information 215 and hop count fields 210, which may be similar to the control information 215 and hop count fields 210 as described with reference to FIG. 2. In some aspects, the UE 115-x may be associated with a network 205-b (e.g., may be a member of the network 205-b, after a discovery procedure), and the UE 115-x may update a UE-specific hop limit 225 to be greater than a previous (e.g., initial, old, outdated) UE-specific hop limit 225.

In some cases, the UE 115-x (e.g., an end UE, a relay UE, a member of the MANET) may transmit control information 215-c-1 to update one or more aspects of control information 215 associated with the UE 115-x (e.g., as stored at one or more other UEs 115 of the network 205-b). In some cases, the UE 115-x may update the UE-specific hop limit 225 based on changing a latency threshold associated with the UE 115-x, changing a service associated with the UE 115-x, or both. For example, the control information 215-c-1 may update one or more of the application layer ID, the IP address, and the UE-specific hop limit 225 associated with the UE 115-x. In some cases, the control information 215-c-1 may be transmitted as a link modification message in a link modification procedure, as an ID update message of an ID update procedure, or any combination thereof.

For cases in which the control information 215-c-1 updates the UE-specific hop limit 225 from a previous UE-specific hop limit 225 to a current (e.g., updated, new) UE-specific hop limit 225, the UEs 115 of the network 205-b may use discovery information messages (e.g., of a MANET discovery information procedure) to update the UE-specific hop limit 225 for the UE 115-x at various other UEs 115 (e.g., relay UEs 115). For example, an entry indicating the update may be propagated to the greater of the previous UE-specific hop limit 225 and the current UE-specific hop limit 225, such that UEs 115 that are beyond the previous UE-specific hop limit 225 from the UE 115-x (e.g., along a greater quantity of hops from the UE 115-x) may store the current UE-specific hop limit 225 for the UE 115-x when the current UE-specific hop limit 225 is greater than the previous UE-specific hop limit 225.

In some cases, a discovery information message to update a UE-specific hop limit 225 for an end UE 115 may include an entry 330-a indicating the current UE-specific hop limit 225 and an entry 330-b indicating the previous UE-specific hop limit 225. Each entry 330 may include a status bit 340, which may be set to a first value to be an “add” status bit, to a second value to be a “remove” status bit, or to a third value to be an “update” status bit. For example, the status bit 340-a may be an “add” status bit and may indicate to a receiving UE 115 to store the information in the entry 330-a. The status bit 340-b may be a “remove” status bit and may indicate to a receiving UE 115 to delete or remove information that is stored at the UE 115 corresponding to the information in the entry 330-b. An “update” status bit may be used to indicate to a receiving UE 115 to replace stored information for the UE 115 identified by the entry 330 with the new information in the entry 330.

For example, the UE 115-x may transmit the control information 215-c-1 to update the UE-specific hop limit 225 from N to N+1. The UE 115-a may receive the control information 215-c-1 and determine that the UE-specific hop limit 225 for the UE 115-x is being updated. Accordingly, the UE 115-a may generate a discovery information message that includes (e.g., for the UE 115-x) an entry 330-b for the original UE-specific hop limit 225 (e.g., assuming the original UE-specific hop limit 225 was greater than one) with status bit 340-b set to “remove.” The UE 115-a may also include (e.g., for the UE 115-x) an entry 330-a for the control information 215-c-2, which may include the new UE-specific hop limit 225 and the status bit 340-a set to “add.” The UE 115-a may broadcast the generated discovery information message, which may be received by the UE 115-b and the UE 115-c, among other UEs 115.

In some cases, the entries 330 of the discovery information message may be included in the discovery message between UEs 115 within the network 205-b independently based on the respective associated UE-specific hop limit 225. For example, the entry 330-a may be propagated until the (N+1)th UE 115 along a given relay path based on the current UE-specific hop limit 225, and the entry 330-b may be propagated until the Nth UE 115 based on the previous UE-specific hop limit 225. As an example, the UE 115-N may receive a discovery information message including the entry 330-a including the control information 215-c-N and the entry 330-b. Based on either the hop count fields 210 being incremented, the UE-specific hop limits 225 of each entry 330 being decremented, or both (e.g., as described herein), the UE 115-N may generate a discovery information message that includes the entry 330-a for the current (e.g., increased) UE-specific hop limit 225 and the control information 215-c-o and excludes the entry 330-b for the previous UE-specific hop limit 225. Accordingly, each UE 115 of the network 205-b that has stored or will store control information 215 associated with the UE 115-x may be updated based on the updated UE-specific hop limit 225 selected by the UE 115-x.

FIG. 4 shows an example of a communication configuration 400 that supports device-specific hop limits for relay handling. Aspects of the communication configuration 400 may implement or be implemented by aspects of a communication system 100, a communication configuration 200, or a communication configuration 300. For example, the communication configuration 400 may include UEs 115 (e.g., of a network 205-b), which may be examples of the UEs 115 described herein. Additionally, the communication configuration 400 may include control information 215 and hop count fields 210, which may be similar to the control information 215 and hop count fields 210 as described herein with reference to FIGS. 2 and 3. In some aspects, the UE 115-x may be associated with a network 205-c (e.g., may be a member of the network 205-c, after a discovery procedure), and the UE 115-x may update a UE-specific hop limit 225 to be less than a previous (e.g., initial, old, outdated) UE-specific hop limit 225.

When the control information 215-c-1 updates the UE-specific hop limit 225 from the previous UE-specific hop limit 225 to a current (e.g., updated, new) UE-specific hop limit 225, the relay UEs of the network 205-c may use discovery information messages (e.g., a MANET discovery information procedure) to update the UE-specific hop limit 225 for the UE 115-x for various other UEs 115 of the network 205-c. For example, the update may be propagated to the greater of the first hop limit and the second hop-limit, such that UEs 115 beyond the current UE-specific hop limit 225 may remove (e.g., delete) the previous UE-specific hop limit 225 from storage at the UEs 115 if the current UE-specific hop limit 225 is less than the previous UE-specific hop limit 225.

In one example, the UE 115-x may transmit the control information 215-d-1 to update the UE-specific hop limit 225 from N to N-1. The UE 115-a may receive the control information 215-d-1 and may determine that the UE-specific hop limit 225 for the UE 115-x is being updated. Accordingly, the UE 115-a may generate a discovery information message that includes an entry 330-d for the previous UE-specific hop limit 225 (e.g., assuming the previous UE-specific hop limit 225 was greater than 1) with status bit 340-d set to “remove.” The discovery information message may also include an entry 330-c for the control information 215-d-2, which may include the new UE-specific hop limit 225 and the status bit 340-c set to “add.” The UE 115-a may broadcast the generated discovery information message, which may be received by the UE 115-b and the UE 115-c, among other UEs 115 of the network 205-c.

In some cases, the entries 330 of the discovery information message may be included in the discovery message based on the respective associated UE-specific hop limit 225. For example, the entry 330-c may be propagated until the (N-1)th relay UE (e.g., a UE 115-M) based on the current UE-specific hop limit 225, and the entry 330-d may be propagated until the Nth relay UE (e.g., the UE 115-N) based on the previous UE-specific hop limit 225. As an example, the UE 115-M (e.g., the (N-1)th UE 115 along a relay path) may receive a discovery information message including the entry 330-c with the control information 215-d-M and the current UE-specific hop limit 225 and the entry 330-d for the previous UE-specific hop limit 225. Based on either the hop count fields 210 being incremented, the UE-specific hop limits 225 of each entry 330 being decremented, or both (e.g., as described herein), the UE 115-M may generate a discovery information message that includes the entry 330-d for the previous UE-specific hop limit 225 and excludes the entry 330-b for the current (e.g., reduced) UE-specific hop limit 225. Accordingly, each UE 115 of the network 205-b that has stored or will store control information 215 associated with the UE 115-x may be updated based on the UE-specific hop limit 225 selected by the UE 115-x.

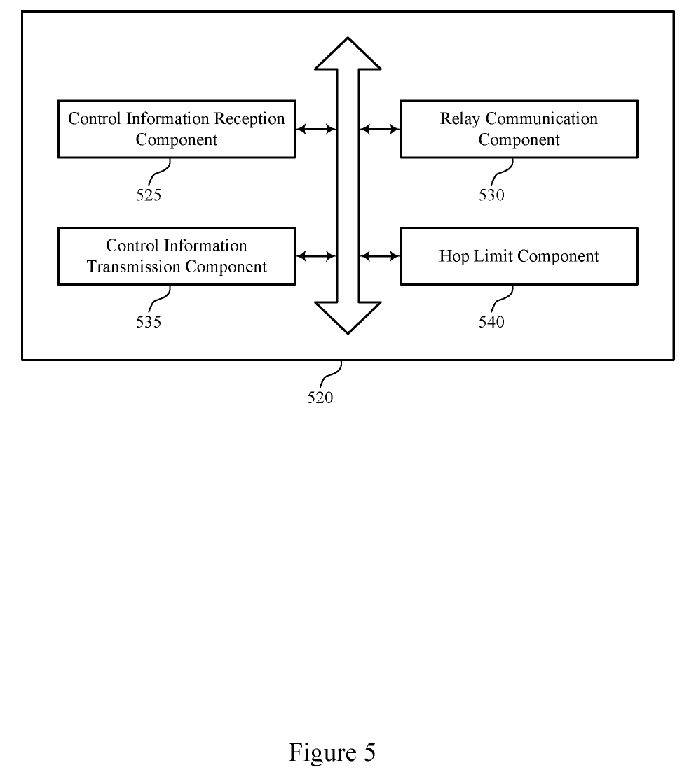

FIG. 5 shows an example of a processing system 520 that supports device-specific hop limits for relay handling. A processing system 520 may be an example of a processing system 140 (such as of a UE 115) and may include a control information reception component 525, a relay communication component 530, a control information transmission component 535, a hop limit component 540, or any combination thereof. A processing system 520, or various component thereof, may be an example of means for performing (such as a means for causing a UE 115 to perform) various techniques described herein.

The control information reception component 525 may be configured to cause the UE 115 to receive, at a first UE associated with a UE-to-UE network, control information that indicates a UE-specific quantity of relays for communications of a second UE. The relay communication component 530 may be configured to cause the UE 115 to perform one or more communications of the UE-to-UE network, at the first UE, in accordance with the UE-specific quantity of relays for communications of the second UE.

In some examples, the UE-specific quantity of relays for communications of the second UE is different from a threshold quantity of relays associated with the UE-to-UE network.

In some examples, to support receiving the control information, the control information reception component 525 may be configured to cause the UE 115 to receive (e.g., from the second UE) a link establishment message that indicates the UE-specific quantity of relays for communications of the second UE.

In some examples, to support receiving the control information, the control information reception component 525 may be configured to cause the UE 115 to receive (e.g., from the second UE) a link modification message or an ID update message, and the link modification message or the ID update message may indicate the UE-specific quantity of relays for communications of the second UE.

In some examples, to support receiving the control information, the control information reception component 525 may be configured to cause the UE 115 to receive, from a third UE associated with the UE-to-UE network, a discovery information message that includes an entry associated with the second UE, and the entry may indicate the UE-specific quantity of relays for communications of the second UE.

In some examples, to support performing the one or more communications of the UE-to-UE network, the relay communication component 530 may be configured to cause the UE 115 to increment a value of a relay count field of the control information based on the value of the relay count field being less than the UE-specific quantity of relays. In some examples, to support performing the one or more communications of the UE-to-UE network, the relay communication component 530 may be configured to cause the UE 115 to transmit a discovery information message including an entry associated with the second UE, and the entry may indicate the incremented value of the relay count field.

In some examples, to support performing the one or more communications of the UE-to-UE network, the relay communication component 530 may be configured to cause the UE 115 to transmit, based on a value of a relay count field in the control information being equal to the UE-specific quantity of relays, a discovery message that omits an entry associated with the second UE.

In some examples, to support performing the one or more communications of the UE-to-UE network, the relay communication component 530 may be configured to cause the UE 115 to decrement the UE-specific quantity of relays indicated by the control information based on the UE-specific quantity of relays satisfying a threshold quantity of relays. In some examples, to support performing the one or more communications of the UE-to-UE network, the relay communication component 530 may be configured to cause the UE 115 to transmit second control information that indicates the decremented UE-specific quantity of relays.

In some examples, to support performing the one or more communications of the UE-to-UE network, the relay communication component 530 may be configured to cause the UE 115 to transmit, based on the UE-specific quantity of relays failing to satisfy a threshold quantity of relays, a discovery message that omits an entry associated with the second UE.

In some examples, the control information reception component 525 may be configured to cause the UE 115 to receive second control information that indicates a second UE-specific quantity of relays for communications of a third UE. In some examples, to perform the one or more communications of the UE-to-UE network, the relay communication component 530 may be configured to cause the UE 115 to transmit a discovery information message including a first discovery entry associated with the second UE and a second discovery entry associated with the third UE, and the first discovery entry may include the control information and the second discovery entry may include the second control information.

In some examples, to support performing the one or more communications of the UE-to-UE network, the relay communication component 530 may be configured to cause the UE 115 to transmit a first discovery information message including a first discovery entry associated with the second UE, and the first discovery entry may include the control information. In some examples, the control information reception component 525 may be configured to cause the UE 115 to receive second control information that indicates a second UE-specific quantity of relays for communications of a third UE, and the relay communication component 530 may be configured to cause the UE 115 to transmit a second discovery information message including a second discovery entry associated with the third UE, and the second discovery entry may include the second control information.

In some examples, to support performing the one or more communications of the UE-to-UE network, the relay communication component 530 may be configured to cause the UE 115 to transmit, based on the UE-specific quantity of relays being a replacement for a previous UE-specific quantity of relays for communications of the second UE, a discovery information message including a first discovery entry and a second discovery entry, and the first discovery entry may indicate the UE-specific quantity of relays and an add status bit, and the second discovery entry may indicate the previous UE-specific quantity of relays for communications of the second UE and a remove status bit.

In some examples, the control information further indicates one or more of an application layer ID associated with the second UE, an IP address associated with the second UE, or other parameters associated with the second UE.

In some examples, to support performing the one or more communications using the UE-to-UE network, the relay communication component 530 may be configured to cause the UE 115 to receive a query associated with the second UE that indicates an application layer ID of a third UE associated with the UE-to-UE network. In some examples, to support performing the one or more communications using the UE-to-UE network, the relay communication component 530 may be configured to cause the UE 115 to transmit, based on the third UE being accessible within the UE-specific quantity of relays from the second UE, a response to the query that indicates an IP address of the third UE.

In some examples, the UE-specific quantity of relays is based on one or more of a threshold latency associated with the second UE, a service type associated with the second UE, or other parameters associated with the second UE.

Additionally, or alternatively, the control information transmission component 535 may be configured to cause the UE 115 to transmit control information that indicates a UE-specific quantity of relays for communications of the UE via a UE-to-UE network. In some examples, the relay communication component 530 may be configured to cause the UE 115 to perform one or more communications via the UE-to-UE network in accordance with the UE-specific quantity of relays for communications of the UE.

In some examples, the hop limit component 540 may be configured to cause the UE 115 to set the UE-specific quantity of relays based on one or more of a threshold latency associated with the UE, a service type associated with the UE, or other parameters associated with the UE.

In some examples, the UE-specific quantity of relays is different from a threshold quantity of relays associated with the UE-to-UE network.

In some examples, to support transmitting the control information, the control information transmission component 535 may be configured to cause the UE 115 to transmit a link establishment message that indicates the UE-specific quantity of relays for communications of the UE.

In some examples, to support transmitting the control information, the control information transmission component 535 may be configured to cause the UE 115 to transmit a link modification message or an ID update message, and the link modification message or the ID update message may include the UE-specific quantity of relays for communications of the UE.

In some examples, to support transmitting the control information, the control information transmission component 535 may be configured to cause the UE 115 to transmit a discovery entry update that indicates the UE-specific quantity of relays as a replacement for a previous UE-specific quantity of relays for communications of the UE.

In some examples, to support performing the one or more communications using the UE-to-UE network, the relay communication component 530 may be configured to cause the UE 115 to transmit a query associated with the UE that indicates an application layer ID of a second UE associated with the UE-to-UE network. In some examples, to support performing the one or more communications using the UE-to-UE network, the relay communication component 530 may be configured to cause the UE 115 to receive, based on the second UE being accessible within the UE-specific quantity of relays from the UE, a response to the query that indicates an IP address of the second UE. In some examples, to support performing the one or more communications using the UE-to-UE network, the relay communication component 530 may be configured to cause the UE 115 to transmit a communication to the second UE based on the IP address of the second UE.

A processing system 520 may include or be a component of one or more chips, systems-on-chips (SoCs), chipsets, packages, components, or devices that individually or collectively constitute or include a processing system. A processing system 520 may interface with other components of a processing system 520. For example, operations described with reference to a processing system 520, or various components thereof, may be performed by or with other such components, including a receiver, a transmitter, a transceiver, a modem, a user interface, a modulator/demodulator, an encoder/decoder, or any combination thereof (such as of the processing system 520, coupled with the processing system 520).

By including or configuring a processing system 520 for operation in a processing system 520 as described herein, the processing system 520 may support techniques for reduced power consumption, more efficient utilization of communication resources. For example, the techniques described herein may enable a MANET to utilize UE-specific hop limits, which reduce instances of communicating information within a MANET that will not be used for communicating with the UE. Such a reduction in communications may conserve power and communication resources at the relay UEs of the MANET.

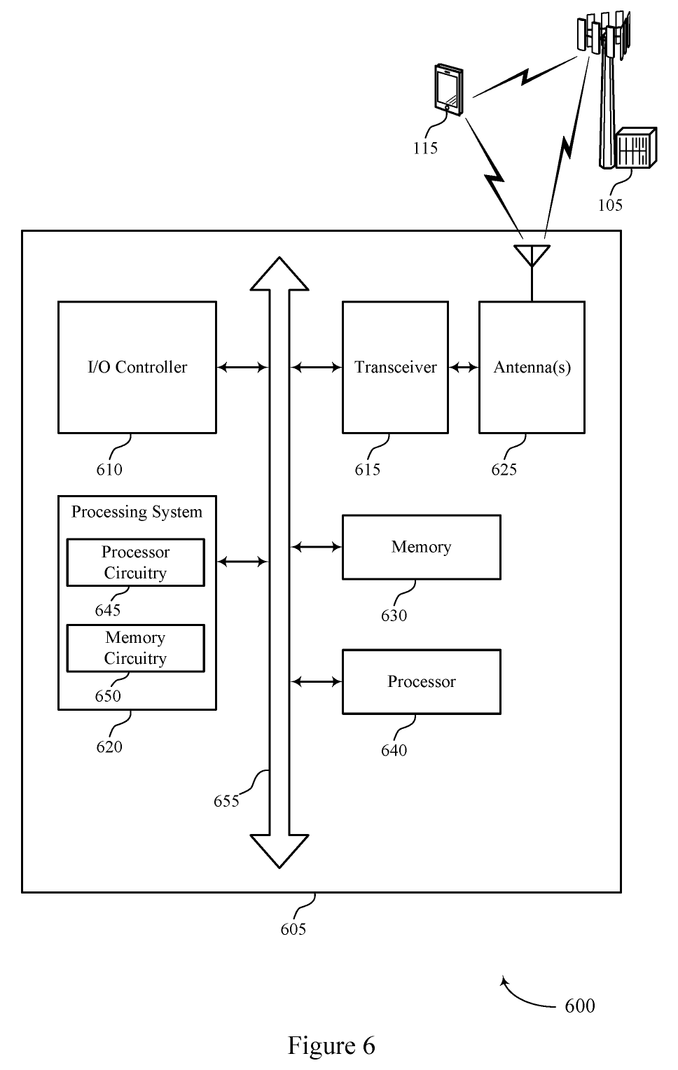

FIG. 6 shows an example of a system 600 including a device 605 that supports device-specific hop limits for relay handling. The device 605 may be an example of or include components of UE 115. The device 605 may communicate (such as wirelessly) with one or more other devices (such as network entities 105, UEs 115). The device 605 may include components for transmitting and receiving communication, which may include a processing system 620, an input/output (I/O) controller, such as an I/O controller 610, a transceiver 615, antenna(s) 625, a memory 630, and a processor 640. Components of the device 605 may be coupled (such as operatively, communicatively, functionally, electronically, electrically, in electronic communication) a bus 655.

The transceiver 615 may support bi-directional communication via antenna(s) 625, and may support transmission operations, reception operations, or both, as described herein. The transceiver 615 may implement functionality of a modem (such as a wireless modem) and may include one or more RF chains. An RF chain may include one or more filters, mixers, oscillators, amplifiers, analog-to-digital converters (ADCs), and other components that convert between an analog signal (such as for transmission or reception via an air interface) and a digital signal (such as for digital processing at the device 605). The transceiver 615 may modulate symbols and provide the modulated symbols to antenna(s) 625 for transmission, and demodulate symbols from signals received using antenna(s) 625.

The processor 640 may be a general-purpose processing component that supports various operations (such as applications) of the device 605. The memory 630 may be a general-purpose storage component that stores code executable by the processor 640. Such code may include instructions that, when executed by the processor 640, cause the device 605 to perform various functions (such as to support an application of the device 605). The I/O controller 610 may manage inputs and outputs for the device 605, may manage peripherals not integrated into the device 605, or may represent a physical connection (such as port) to an external peripheral. The processor 640 may interact with a modem, a keyboard, a mouse, a touchscreen, or other device (such as via I/O controller 610). In some implementations, a user may interact with the device 605 via the I/O controller 610 or via hardware components controlled by the I/O controller 610.

The processing system 620 may be an example of a processing system 140 or a processing system 520. For example, the processing system 620 may include processor circuitry 645 and memory circuitry 650 that stores code, and may be configured to cause the device 605 to perform operations that support device-specific hop limits for relay handling. Although the processing system 620 is illustrated as a separate component, which may involve a separate chip, chipset, or other module, in some implementations, one or more functions described with reference to the processing system 620 may be supported by or performed by a transceiver 615, antenna(s) 625, a processor 640, memory 630, or any combination thereof, such that a processing system 620 may include one or more of a transceiver 615, antenna(s) 625, a processor 640, memory 630, or any combination thereof.

By including or configuring the processing system 620 for operation in the device 605 as described herein, may support techniques for improved communication reliability, reduced latency, and more efficient utilization of communication resources. For example, the techniques described herein enable a MANET (e.g., network 205) to limit control information and communication propagation based on UE-specific hop limits, which may reduce resource usage. Additionally, a UE may set the UE-specific hop limits based on one or more of a threshold latency associated with the UE, a service requested by the UE, or other parameter(s) associated with the UE, such that applying the UE-specific hop limit may improve the reliability of communications to be within a latency threshold, and may reduce the latency caused by large quantities of relays for communications associated with the UE.

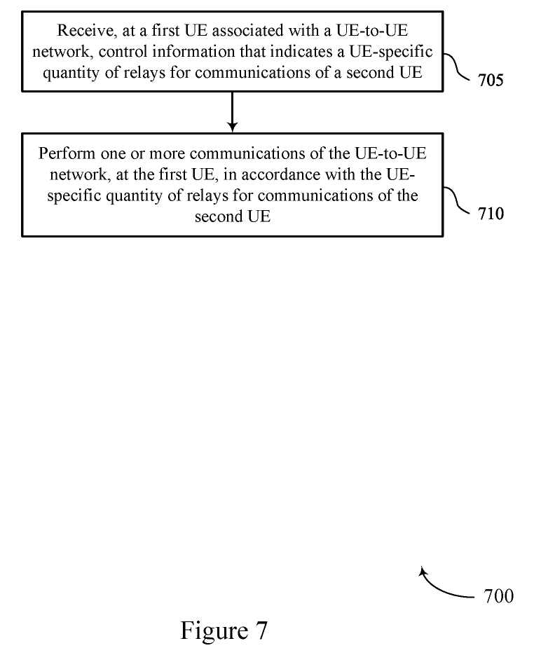

FIG. 7 shows an example of a method 700 that supports device-specific hop limits for relay handling. Operations of the method 700 may be performed by a UE or its components (such as using a processing system configured to cause the UE 115 to perform one or more of the operations) as described herein.

At 705, the method 700 may include receiving, at a first UE associated with a UE-to-UE network, control information that indicates a UE-specific quantity of relays for communications of a second UE. In some examples, aspects of the operations of 705 may be performed by a control information reception component 525.

At 710, the method 700 may include performing one or more communications of the UE-to-UE network, at the first UE, in accordance with the UE-specific quantity of relays for communications of the second UE. In some examples, aspects of the operations of 710 may be performed by a relay communication component 530.

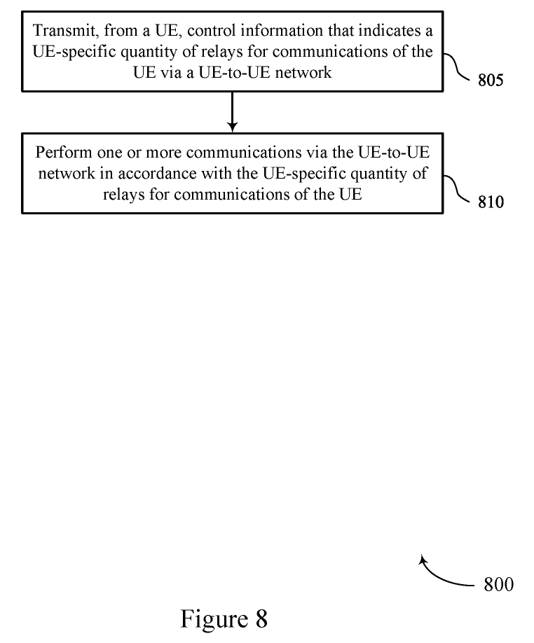

FIG. 8 shows an example of a method 800 that supports device-specific hop limits for relay handling. Operations of the method 800 may be performed by a UE or its components (such as using a processing system configured to cause the UE 115 to perform one or more of the operations) as described herein.

At 805, the method 800 may include transmitting, from a UE, control information that indicates a UE-specific quantity of relays for communications of the UE via a UE-to-UE network. In some examples, aspects of the operations of 805 may be performed by a control information transmission component 535.

At 810, the method 800 may include performing one or more communications via the UE-to-UE network in accordance with the UE-specific quantity of relays for communications of the UE. In some examples, aspects of the operations of 810 may be performed by a relay communication component 530.

Implementation examples are described in the following numbered clauses:

Aspect 1: A method for wireless communications, comprising: receiving, at a first UE associated with a UE-to-UE network, control information that indicates a UE-specific quantity of relays for communications of a second UE; and performing one or more communications of the UE-to-UE network, at the first UE, in accordance with the UE-specific quantity of relays for communications of the second UE.

Aspect 2: The method of aspect 1, wherein the UE-specific quantity of relays for communications of the second UE is different from a threshold quantity of relays associated with the UE-to-UE network.

Aspect 3: The method of any of aspects 1 through 2, wherein receiving the control information comprises: receiving (e.g., from the second UE, directly or via one or more relays) a link establishment message that indicates the UE-specific quantity of relays for communications of the second UE.

Aspect 4: The method of any of aspects 1 through 2, wherein receiving the control information comprises: receiving (e.g., from the second UE) a link modification message or an ID update message, wherein the link modification message or the ID update message indicates the UE-specific quantity of relays for communications of the second UE.

Aspect 5: The method of any of aspects 1 through 2, wherein receiving the control information comprises: receiving, from a third UE associated with the UE-to-UE network, a discovery information message that comprises an entry associated with the second UE, wherein the entry indicates the UE-specific quantity of relays for communications of the second UE.

Aspect 6: The method of any of aspects 1 through 5, wherein performing the one or more communications of the UE-to-UE network comprises: incrementing a value of a relay count field of the control information based at least in part on the value of the relay count field being less than the UE-specific quantity of relays; and transmitting a discovery information message comprising an entry associated with the second UE, wherein the entry indicates the incremented value of the relay count field.

Aspect 7: The method of any of aspects 1 through 5, wherein performing the one or more communications of the UE-to-UE network comprises: transmitting, based at least in part on a value of a relay count field in the control information being equal to the UE-specific quantity of relays, a discovery message that omits an entry associated with the second UE.

Aspect 8: The method of any of aspects 1 through 7, wherein performing the one or more communications of the UE-to-UE network comprises: decrementing the UE-specific quantity of relays indicated by the control information based at least in part on the UE-specific quantity of relays satisfying a threshold quantity of relays; and transmitting second control information that indicates the decremented UE-specific quantity of relays.

Aspect 9: The method of any of aspects 1 through 7, wherein performing the one or more communications of the UE-to-UE network comprises: transmitting, based at least in part on the UE-specific quantity of relays failing to satisfy a threshold quantity of relays, a discovery message that omits an entry associated with the second UE.

Aspect 10: The method of any of aspects 1 through 9, further comprising: receiving second control information that indicates a second UE-specific quantity of relays for communications of a third UE, wherein performing the one or more communications of the UE-to-UE network comprises: transmitting a discovery information message comprising a first discovery entry associated with the second UE and a second discovery entry associated with the third UE, wherein the first discovery entry comprises the control information and wherein the second discovery entry comprises the second control information.

Aspect 11: The method of any of aspects 1 through 9, wherein performing the one or more communications of the UE-to-UE network comprises: transmitting a first discovery information message comprising a first discovery entry associated with the second UE, wherein the first discovery entry comprises the control information, and wherein the method further comprises: receiving second control information that indicates a second UE-specific quantity of relays for communications of a third UE; and transmitting a second discovery information message comprising a second discovery entry associated with the third UE, wherein the second discovery entry comprises the second control information.

Aspect 12: The method of any of aspects 1 through 11, wherein performing the one or more communications of the UE-to-UE network comprises: transmitting, based at least in part on the UE-specific quantity of relays being a replacement for a previous UE-specific quantity of relays for communications of the second UE, a discovery information message comprising a first discovery entry and a second discovery entry, wherein the first discovery entry indicates the UE-specific quantity of relays and an add status bit, and wherein the second discovery entry indicates the previous UE-specific quantity of relays for communications of the second UE and a remove status bit.

Aspect 13: The method of any of aspects 1 through 12, wherein the control information further indicates an application layer ID associated with the second UE, an IP address associated with the second UE, or both.

Aspect 14: The method of any of aspects 1 through 13, wherein performing the one or more communications using the UE-to-UE network comprises: receiving, at the first UE, a query associated with the second UE that indicates an application layer ID of a third UE associated with the UE-to-UE network; and transmitting, based at least in part on the third UE being accessible within the UE-specific quantity of relays from the second UE, a response to the query that indicates an IP address of the third UE.

Aspect 15: The method of any of aspects 1 through 14, wherein the UE-specific quantity of relays is based at least in part on one or more of a threshold latency associated with the second UE, a service type associated with the second UE, or other parameters associated with the second UE.

Aspect 16: A method for wireless communications, comprising: transmitting, from a UE, control information that indicates a UE-specific quantity of relays for communications of the UE via a UE-to-UE network; and performing one or more communications via the UE-to-UE network in accordance with the UE-specific quantity of relays for communications of the UE.

Aspect 17: The method of aspect 16, further comprising: setting the UE-specific quantity of relays based at least in part on one or more of a threshold latency associated with the UE, a service type associated with the UE, or other parameter associated with the UE.

Aspect 18: The method of any of aspects 16 through 17, wherein the UE-specific quantity of relays is different from a threshold quantity of relays associated with the UE-to-UE network.

Aspect 19: The method of any of aspects 16 through 18, wherein transmitting the control information comprises: transmitting a link establishment message that indicates the UE-specific quantity of relays for communications of the UE.

Aspect 20: The method of any of aspects 16 through 18, wherein transmitting the control information comprises: transmitting a link modification message or an ID update message, wherein the link modification message or the ID update message comprises the UE-specific quantity of relays for communications of the UE.

Aspect 21: The method of any of aspects 16 through 18, wherein transmitting the control information comprises: transmitting a discovery entry update that indicates the UE-specific quantity of relays as a replacement for a previous UE-specific quantity of relays for communications of the UE.

Aspect 22: The method of any of aspects 16 through 21, wherein performing the one or more communications using the UE-to-UE network comprises: transmitting a query associated with the UE that indicates an application layer ID of a second UE associated with the UE-to-UE network; receiving, based at least in part on the second UE being accessible within the UE-specific quantity of relays from the UE, a response to the query that indicates an IP address of the second UE; and transmitting a communication to the second UE based at least in part on the IP address of the second UE.

Aspect 23: An apparatus for wireless communications, comprising a processing system that includes processor circuitry and memory circuitry that stores code, the processing system configured to cause the apparatus to perform a method of any of aspects 1 through 15.

Aspect 24: An apparatus for wireless communications, comprising at least one means for performing a method of any of aspects 1 through 15.

Aspect 25: A non-transitory computer-readable medium storing code for wireless communications, the code comprising instructions executable by one or more processors to perform a method of any of aspects 1 through 15.

Aspect 26: An apparatus for wireless communications, comprising a processing system that includes processor circuitry and memory circuitry that stores code, the processing system configured to cause the apparatus to perform a method of any of aspects 16 through 22.

Aspect 27: An apparatus for wireless communications, comprising at least one means for performing a method of any of aspects 16 through 22.

Aspect 28: A non-transitory computer-readable medium storing code for wireless communications, the code comprising instructions executable by one or more processors to perform a method of any of aspects 16 through 22.

It should be noted that methods described herein describe possible implementations. Other implementations in accordance with the described techniques are possible, including implementations in which operations are rearranged or otherwise modified relative to the described methods. Further, aspects from two or more of the described methods may be combined.

Although aspects of 5G or 6G systems may be described for purposes of example and corresponding terminology may be used in the description, the techniques described herein are applicable beyond 5G, or 6G networks. For example, the described techniques may be applicable to other communication systems such as Institute of Electrical and Electronics Engineers (IEEE) 802.11 (Wi-Fi), IEEE 802.20, Flash-OFDM, or other systems and radio technologies not explicitly mentioned herein.

As used herein, a processing system (such as a processing system 140, a processing system 145) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform functions or operations described herein. A group of processors collectively configurable or configured to cause a device to perform a set of functions may include a first processor configured to cause the device to perform a first function of the set and a second processor configured to cause the device to perform a second function of the set. In some other examples, each of a group of processors may be configured to cause a device to perform a same set of functions.

As used herein, a processing system (such as a processing system 140, a processing system 145) also includes memory circuitry in the form of one or multiple memory devices, memory blocks, memory elements, or other discrete gate or transistor logic or circuitry, each of which may include or implement tangible storage media such as random-access memory (RAM) or read-only memory (ROM), or combinations thereof (any one or more of which may be generally referred to herein individually as a “memory” or collectively as “the memory” or “the memory circuitry”). One or more of the memories may be coupled (such as operatively, communicatively, electronically, electrically) with one or more processors of the processor circuitry and may individually or collectively store processor-executable code or instructions (such as software) that, when executed by one or more of the processors (such as directly, indirectly, after pre-processing, without pre-processing, after compilation), may cause a device (such as configure the device, using one or more of the processors) to perform functions or operations described herein. Additionally, or alternatively, in some examples, one or more of the processors may be configured to cause a device to perform functions or operations described herein without requiring configuration by software. As used herein, “software” shall be construed to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

As used herein, a processing system (such as a processing system 140, a processing system 145) may include or be coupled with one or more modems (such as a cellular modem, a 5G-compliant modem, a 6G-compliant modem). In some examples, one or more processors of a processing system may include or implement one or more of the modems. A processing system also may include or be coupled with multiple radios (collectively “the radio”), multiple RF chains, or multiple transceivers, each of which may in turn be coupled with one or more of multiple antennas. In some examples, one or more processors of a processing system may include or implement one or more of the radios, RF chains, or transceivers. An RF chain may include one or more filters, mixers, oscillators, amplifiers, analog-to-digital converters (ADCs), or other devices that convert between an analog signal (such as for transmission or reception via an air interface) and a digital signal (such as for processing by processor circuitry).

As described herein, being “configured to,” being “configurable to,” and being “operable to” may be used interchangeably and may be associated with a capability, when executing code (such as processor-executable code, instructions) stored in memory circuitry (such as a non-transitory computer-readable medium, of the memory circuitry, storing code for wireless communication that is executable by a processing system) or otherwise, to perform one or more of the functions described herein.

As used herein, the term “determine” or “determining” can encompass one or more of a variety of actions. For example, “determining” can include one or more of calculating, computing, processing, deriving, detecting, estimating, looking up, inferring, ascertaining, measuring, resolving, selecting, obtaining, identifying, interpreting, demodulating, decoding, reading, establishing, forming, or generating, among other examples. In some such examples, determining can involve a processing system performing some type of calculating, computing, deriving, estimating, inferring, ascertaining, resolving, predicting, or other processing to obtain one or more numerical values, sets, elements, or other information or results. In some such examples, determining can involve a processing system identifying, looking up, investigating or otherwise obtaining some type of value, set, element, or other information or result from a table, data structure, database, or an implementation of memory, such as from a larger set of values, sets, or elements or other information or results. In some such examples, determining can involve a processing system identifying, interpreting, demodulating, decoding, detecting, reading, or otherwise obtaining some type of value, set, element, or other information or result signaled in, for example, a received wireless signal. In some such examples, determining can involve a processing system performing a measurement, such as on a received signal.

As used herein, the phrase “associated with” is intended to be interpreted in the inclusive sense, unless otherwise explicitly indicated. For example, the phrase “associated with” is not to be construed as a reference to a closed set of conditions, factors, criteria, elements, components or actions, among other examples. Specifically, unless a phrase refers to “associated with only ‘a,’” or the equivalent in context, whatever it is that is “associated with ‘a,’” may be associated with “a” alone or associated with a combination of “a” and one or more other conditions, factors, criteria, elements, components or actions, among other examples. The phrase “associated with” may be interpreted to mean or be interchanged with “in association with,” “in accordance with,” “based on,” “based at least in part on,” “as a function of,” “in response to,” “responsive to,” “using,” “coupled with,” in communication with,” “configured with,” “included with,” or “in cooperation with,” as appropriate in the relevant context unless otherwise explicitly indicated. Additionally, the use of such phrases does not indicate that what follows the phrase is the focal point or primary factor associated with the limitation preceding the phrase.

As used herein, a phrase referring to “at least one of” or “one or more of” a list of items refers to any combination of those items, including single members. For example, “at least one of: a, b, or c” is intended to cover: a, b, c, a-b, a-c, b-c, and a-b-c. Additionally, as used herein, a phrase referring to “a” or “an” element refers to one or more of such elements acting individually or collectively to perform the recited function(s). Thus, the terms “a,” “at least one,” “one or more,” and “at least one of one or more” may be interchangeable. For instance, for a claim that refers to “a” component performing one or more functions, each of the individual functions may be performed by a single component or by any combination of multiple components, and subsequent reference to a component introduced with the article “a” using the term “the” may refer to any or all of the single or multiple components. Thus, a component introduced with the article “a” may be understood to mean “one or more” components, and referring to “the” component subsequently in the claims may be understood to be equivalent to referring to “at least one of the one or more” components. Additionally, as used herein, a “set” can refer to one or more items, and a “subset” can refer to a whole set or less than the whole set, but not an empty set. Additionally, as used herein, the term “or” is intended to be interpreted in the inclusive sense, such as when referring to a series, and may be used interchangeably with the term “and/or,” unless otherwise explicitly indicated (for example, if used in conjunction with “either” or “only one of”). For example, “a or b” may include a only, b only, or a combination of a and b.

The disclosure is provided to enable a person having ordinary skill in the art to implement the described techniques. Modifications to the disclosure will be apparent to a person having ordinary skill in the art, and the techniques disclosed herein may be applied with other variations without departing from the scope of the disclosure. Thus, the disclosure is not limited to the examples and designs described herein but is to be accorded the broadest scope consistent with the principles and novel features disclosed herein.

What is claimed is:

1. An apparatus for wireless communication at a first user equipment (UE), comprising:
a processing system that includes processor circuitry and memory circuitry that stores code, the processing system configured to cause the first UE to:
receive, at the first UE that is associated with a UE-to-UE network, control information that indicates a UE-specific quantity of relays for communications of a second UE; and
perform one or more communications of the UE-to-UE network, at the first UE, in accordance with the UE-specific quantity of relays for communications of the second UE.

2. The apparatus of claim 1, wherein the UE-specific quantity of relays for communications of the second UE is different from a threshold quantity of relays associated with the UE-to-UE network.

3. The apparatus of claim 1, wherein, to receive the control information, the processing system is configured to cause the first UE to:
receive a link establishment message that indicates the UE-specific quantity of relays for communications of the second UE.

4. The apparatus of claim 1, wherein, to receive the control information, the processing system is configured to cause the first UE to:
receive a link modification message or an identifier update message, wherein the link modification message or the identifier update message indicates the UE-specific quantity of relays for communications of the second UE.

5. The apparatus of claim 1, wherein, to receive the control information, the processing system is configured to cause the first UE to:
receive, from a third UE associated with the UE-to-UE network, a discovery information message that comprises an entry associated with the second UE, wherein the entry indicates the UE-specific quantity of relays for communications of the second UE.

6. The apparatus of claim 1, wherein, to perform the one or more communications of the UE-to-UE network, the processing system is configured to cause the first UE to:
increment a value of a relay count field of the control information based at least in part on the value of the relay count field being less than the UE-specific quantity of relays; and
transmit a discovery information message comprising an entry associated with the second UE, wherein the entry indicates the incremented value of the relay count field.

7. The apparatus of claim 1, wherein, to perform the one or more communications of the UE-to-UE network, the processing system is configured to cause the first UE to:
transmit, based at least in part on a value of a relay count field in the control information being equal to the UE-specific quantity of relays, a discovery message that omits an entry associated with the second UE.

8. The apparatus of claim 1, wherein the processing system is further configured to cause the first UE to:
receive second control information that indicates a second UE-specific quantity of relays for communications of a third UE, wherein, to perform the one or more communications of the UE-to-UE network, the processing system is configured to cause the first UE to:
transmit a discovery information message comprising a first discovery entry associated with the second UE and a second discovery entry associated with the third UE, wherein the first discovery entry comprises the control information and wherein the second discovery entry comprises the second control information.

9. The apparatus of claim 1, wherein, to perform the one or more communications of the UE-to-UE network, the processing system is configured to cause the first UE to:
transmit, based at least in part on the UE-specific quantity of relays being a replacement for a previous UE-specific quantity of relays for communications of the second UE, a discovery information message comprising a first discovery entry and a second discovery entry, wherein the first discovery entry indicates the UE-specific quantity of relays and an add status bit, and wherein the second discovery entry indicates the previous UE-specific quantity of relays for communications of the second UE and a remove status bit.

10. The apparatus of claim 1, wherein the control information further indicates an application layer identifier associated with the second UE, an internet protocol address associated with the second UE, or both.

11. The apparatus of claim 1, wherein, to perform the one or more communications using the UE-to-UE network, the processing system is configured to cause the first UE to:
receive a query associated with the second UE that indicates an application layer identifier of a third UE associated with the UE-to-UE network; and
transmit, based at least in part on the third UE being accessible within the UE-specific quantity of relays from the second UE, a response to the query that indicates an internet protocol address of the third UE.

12. The apparatus of claim 1, wherein the UE-specific quantity of relays is based at least in part on one or more of a threshold latency associated with the second UE, a service type associated with the second UE, or other parameters associated with the second UE.

13. An apparatus for wireless communication at a user equipment (UE), comprising:
a processing system that includes processor circuitry and memory circuitry that stores code, the processing system configured to cause the UE to:
transmit, from the UE, control information that indicates a UE-specific quantity of relays for communications of the UE via a UE-to-UE network; and
perform one or more communications via the UE-to-UE network in accordance with the UE-specific quantity of relays for communications of the UE.

14. The apparatus of claim 13, wherein the processing system is further configured to cause the UE to:
set the UE-specific quantity of relays based at least in part on one or more of a threshold latency associated with the UE, a service type associated with the UE, or other parameters associated with the UE.

15. The apparatus of claim 13, wherein the UE-specific quantity of relays is different from a threshold quantity of relays associated with the UE-to-UE network.

16. The apparatus of claim 13, wherein, to transmit the control information, the processing system is configured to cause the UE to:
transmit a link establishment message that indicates the UE-specific quantity of relays for communications of the UE.

17. The apparatus of claim 13, wherein, to transmit the control information, the processing system is configured to cause the UE to:
transmit a link modification message or an identifier update message, wherein the link modification message or the identifier update message comprises the UE-specific quantity of relays for communications of the UE.

18. The apparatus of claim 13, wherein, to transmit the control information, the processing system is configured to cause the UE to:
transmit a discovery entry update that indicates the UE-specific quantity of relays as a replacement for a previous UE-specific quantity of relays for communications of the UE.

19. The apparatus of claim 13, wherein, to perform the one or more communications using the UE-to-UE network, the processing system is configured to cause the UE to:
transmit a query associated with the UE that indicates an application layer identifier of a second UE associated with the UE-to-UE network;
receive, based at least in part on the second UE being accessible within the UE-specific quantity of relays from the UE, a response to the query that indicates an internet protocol address of the second UE; and
transmit a communication to the second UE based at least in part on the internet protocol address of the second UE.

20. A method for wireless communications, comprising:
receiving, at a first user equipment (UE) associated with a UE-to-UE network, control information that indicates a UE-specific quantity of relays for communications of a second UE; and
performing one or more communications of the UE-to-UE network, at the first UE, in accordance with the UE-specific quantity of relays for communications of the second UE.
